(19) United States
(12) Patent Application Publication
(10) Pub. No.: US 2009/0312084 A1
(43) Pub. Date: Dec. 17, 2009

(54) GAMING MACHINE, PLAYING METHOD AND GAMING SYSTEM WHICH CHANGE PLURAL GAMES WHICH ARE DIFFERENT IN THE AMOUNT OF MAXIMUM BET

(75) Inventor: Yukinori Inamura, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aruze Corp., Koto-ku (JP)

(21) Appl. No.: 12/235,299

(22) Filed: Sep. 22, 2008

Related U.S. Application Data
(60) Provisional application No. 61/061,490, filed on Jun. 13, 2008.

(51) Int. Cl. A63F 13/00

(52) U.S. Cl. 463/20

(57) ABSTRACT

The gaming machine includes: a plurality of gaming terminals each having an input device through which an input from outside is inputted; a payout memory which stores a payout rate of each of the base games, for a predetermined winning; and a bonus payout memory which accumulatively stores a part of a bet on a predetermined base game as a resource for a bonus payout. In the gaming machine, a base game determined based on an input through the input device is run in each of the gaming terminals. When the base game is the predetermined base game, a bet within a wider bettable range compared to another base game is permitted, and a part of the bet is accumulatively stored in the bonus payout memory. A payout according to a predetermined winning resulted in a base game is awarded, based on a payout rate associated with the base game and a bet on the base game. A bonus payout is awarded based on a predetermined condition.

### CROSS REFERENCE TO RELATED APPLICATION

The present application claims priority from provisional application No. 61/061,490 which was filed on Jun. 13, 2008, the entire disclosure of which is herein incorporated by reference.

### BACKGROUND OF THE INVENTION

1. Field of the Invention

The present invention relates to a gaming machine, a playing method thereof, and a gaming system.

2. Description of Related Art

Among existing gaming machines, there is a gaming machine including: two or more gaming terminals; terminal controllers respectively provided to the gaming terminals, each of which controllers causes associated one of the gaming terminals to run a game; a center controller for controlling all the terminal controllers. This type of gaming machine is disclosed in specifications of U.S. Pat. No. 5,820,459, No. 4,283,709, or No. 6,003,013. A terminal controller of a gaming terminal runs a game and awards a payout based on the result of the game independently of another terminal controller of another gaming terminal. The center controller provides various jackpots such as progressive jackpots, mystery jackpots, or the like.

An object of the present invention is to provide a gaming machine having an entertainment characteristic which is not brought about by the above mentioned known art, a playing method thereof, and a gaming system.

Specifically, the object of the present invention is to provide a gaming machine providing a new entertainment characteristic which provides a player through a gaming terminal with a plurality of games whose maximum bettable amount are different from one another, a playing method thereof, and a gaming system.

### SUMMARY OF THE INVENTION

A gaming machine of the present invention includes: a plurality of gaming terminals each having an input device through which an input from outside is inputted, and a terminal controller; a plurality of base games which start in response to a bet within a bettable range determined in advance for each of the base games; a payout memory which stores a payout rate of each of the base games, for a predetermined winning; a bonus game which is configured to award a bonus payout greater than a payout awarded in any of the base games, and which is joinable during a predetermined one of the plurality of base games; a bonus payout memory which accumulatively stores a part of a bet on a predetermined base game, as a resource for a bonus payout; and a center controller, wherein the terminal controller carries out the steps of: (a1) selecting a base game to be run out of the plurality of base games, based on an input through the input device; (a2) running the base game in response to a bet, independently of another gaming terminal; (a3) when the base game is the predetermined base game, permitting a bet within a wider bettable range compared to another base game, and accumulatively storing a part of the bet on the predetermined base game, in the bonus payout memory; (a4) awarding a payout according to a predetermined winning resulted in the base game, based on a payout rate associated with the base game and a bet on the base game; and (a5) awarding a bonus payout based on a command from the center controller, and wherein the center controller carries out the steps of: (b1) running a bonus game at a predetermined timing; (b2) of the gaming terminals, selecting a bonus-winning gaming terminal out of one or more gaming terminals running the predetermined base game, based on a predetermined condition; and (b3) commanding the terminal controller of thus determined bonus-winning gaming terminal to award a bonus payout.

According to the above structure, a base game to be run is selected out of the base games, for each of the gaming terminals, based on an input through the input device. The base game is then run in response to a bet, independently of another gaming terminal. When the base game is a predetermined base game, a bet within a wider bettable range compared to another base game is permitted, and a part of a bet on the predetermined base game is accumulatively stored in the bonus payout memory. Then, a payout according to a predetermined winning resulted in the base game is awarded based on a payout rate associated with the base game and a bet on the base game. Further, a bonus game is run at a predetermined timing. Based on a predetermined condition, a gaming terminal through which a bonus payout is awarded (hereinafter, referred to as bonus-winning gaming terminal) is selected out of one or more gaming terminals running the predetermined base game. Through this bonus-winning gaming terminal thus determined is awarded a bonus payout.

As is understood from the above, the input device enables a player to select a base game out of the plurality of base games. Further, the predetermined base game permits a bet within a wider bettable range compared to another base game. Further, a part of a bet on the predetermined base game is accumulatively stored in the bonus payout memory, and used as a bonus payout in a bonus game. In addition, each of the base games has a different payout rate. Thus, a new entertainment characteristic is realized.

A gaming machine of the present invention includes: a plurality of gaming terminals each having an input device through which an input from outside is inputted, a game history memory which stores history information of a game, and a terminal controller; a plurality of base games which start in response to a bet within a bettable range determined in advance for each of the base games; a payout memory which stores a payout rate of each of the base games, for a predetermined winning; a bonus game which is configured to award a bonus payout greater than a payout awarded in any of the base games, and which is joinable during a predetermined one of the plurality of base games; a bonus payout memory which accumulatively stores a part of a bet on a predetermined base game as a resource for a bonus payout; and a center controller, wherein the terminal controller carries out the steps of: (c1) storing in the game history memory a result of a base game as history information, based on a predetermined timing; (c2) determining one or more runnable base games based on the history information; (c3) selecting a base game to run, out of the one or more base games determined as runnable, based on an input inputted through the input device; (c4) running the base game in response to a bet, independently of another gaming terminal; (c5) when the base game is the predetermined base game, permitting a bet within a wider bettable range compared to another base game, and accumulatively storing a part of the bet on the predetermine base game, in the bonus payout memory; (c6) awarding a payout according to a predetermined winning resulted in the base game, based on a payout rate associated with the base game and a bet on the base game; and (c7) awarding a bonus payout based on a command from the center controller, and wherein the center controller carries out the steps of: (d1) running a bonus game at a predetermined timing; (d2) of the gaming terminals, selecting a bonus-winning gaming terminal out of one or more gaming terminals running the predetermined base game, based on a predetermined condition; and (d3) commanding the terminal controller of thus determined bonus-winning gaming terminal to award a bonus payout.

According to the above structure, a result of a base game in each of the gaming terminals, is stored in the game history memory as history information based on a predetermined timing. Based on the history information is determined a runnable base game. Then, out of the one or more base games determined as runnable, a base game to be run is selected, based on an input through the input device. The base game is then run in response to a bet, independently of another gaming terminal. When the base game is a predetermined base game, a bet within a wider range compared to another base game is permitted, and a part of a bet or, the predetermined base game is accumulatively stored in the bonus payout memory. Then, a payout according to a predetermined winning resulted in the base game is awarded based on a payout rate associated with the base game and a bet on the base game. Further, a bonus game is run at a predetermined timing. Based on a predetermined condition, a bonus-winning gaming terminal is selected out of one or more gaming terminals running the predetermined base game. Through this bonus-winning gaming terminal thus determined is awarded a bonus payout.

As is understood from the above, the input device enables a player to select a base game out of the plurality of base games. Further, the predetermined base game permits a bet within a wider range compared to another base game. Further, a part of bet on the predetermined base game is accumulatively stored in the bonus payout memory, and used as a bonus payout in a bonus game. Further, each of the base games has a different payout rate. In addition, a runnable base game is determined based on the history information of a base game. Thus, a new entertainment characteristic is realized.

A gaming system of the present invention includes: a plurality of base games which start in response to a bet within a bettable range determined in advance for each of the base games; a plurality of gaming terminals each having an input device through which an input from outside is inputted, a payout memory which stores a payout rate of each of the base games, for a predetermined winning;, and a terminal controller; a bonus game which is configured to award a bonus payout greater than a payout awarded in any of the base games, and which is joinable during a predetermined one of the plurality of base games; and a management device having a center controller, which is capable of performing data communication with each of the gaming terminals, wherein the terminal controller carries out the steps of: (e1) selecting a base game to be run out of the plurality of base games, based on an input through the input device; (e2) running the base game in response to a bet, independently of another gaming terminal; (e3) when the base game is the predetermined base game, permitting a bet within a wider bettable range of amounts compared to another base game; (e4) awarding a payout according to a predetermined winning resulted in the base game, based on a payout rate associated with the game, and a bet on the base game; and (e5) awarding a bonus payout based on a command from the center controller, and wherein the center controller carries out the steps of: (f1) running a bonus game at a predetermined timing; (f2) of the gaming terminals, selecting a bonus-winning gaming terminal out of one or more gaming terminals running the predetermined base game, based on a predetermined condition; and (f3) commanding the terminal controller of thus determined bonus-winning gaming terminal to award a bonus payout.

According to the above structure, a base game to be run is selected out of the base games, for each of the gaming terminals, based on an input through the input device. The base game is then run in response to a bet, independently of another gaming terminal. When the base game is a predetermined base game, a bet within a wider bettable range compared to another base game is permitted. Then, a payout according to a predetermined winning resulted in the base game is awarded based on a payout rate associated with the base game and a bet on the base game. Further, a bonus game is run in the management device at a predetermined timing. Based on a predetermined condition, a bonus-winning gaming terminal is selected out of one or more gaming terminals running the predetermined base game. Through this bonus-winning gaming terminal thus determined is awarded a bonus payout.

As is understood from the above, the input device enables a player to select a base game out of the plurality of base games. Further, the predetermined base game permits a bet within a wider range compared to another base game. In addition, each of the base games has a different payout rate. Thus, a new entertainment characteristic is real.

The management device of a gaming system of the present invention further includes a bonus payout memory which accumulatively stores a part of a bet on the predetermined base game as a bonus resource. The terminal controller transmits to the management device a part of a bet which causes a predetermined base game to start. The center controller accumulatively stores the received part of the bet in the bonus payout memory.

According to the above structure, a part of a bet on a predetermined base game is accumulatively stored in the bonus payout memory of the management device. Thus, when a predetermined base game is to be run in a gaming terminal, a part of the bet is accumulatively stored in the bonus payout memory of the management device, and is used as a bonus payout in a bonus game. Thus, a new entertainment characteristic is realized.

A playing method of the present invention of a gaming machine includes the steps of: (g1) in each of a plurality of gaming terminals, selecting a base game to be run out of a plurality of base games, based on an input through an input device which receives an input from outside, the plurality of base games configured to start in response to a bet within a bettable range determined in advance for each of the base games; (g2) running the base game in response to a bet, independently of another gaming terminal; (g3) when the base game is a predetermined base game, permitting a bet within a wider bettable range compared to another base game, and accumulatively storing a part of the bet in a bonus payout memory, the predetermined game being a game during which a player is allowed to join a bonus game configured to award a bonus payout greater than a payout awarded in any of the base games, the bonus payout memory storing a resource for a bonus payout; (g4) awarding a payout according to a predetermined winning resulted in the base game, based on a payout rate associated with the base game and a bet on the base game; (g5) running the bonus game at a predetermined timing; (g6) of the gaming terminals, selecting a bonus-winning gaming terminal out of one or more gaming terminals running the predetermined base game, based on a predetermined condition; and (g7) awarding a bonus payout through the bonus-winning gaming terminal.

According to the above structure, the input device enables a player to select a base game out of the plurality of base games. The predetermined base game permits a bet within a wider range compared to another base game. Further, a part of bet on the predetermined base game is accumulatively stored in the bonus payout memory, and used as a bonus payout in a bonus game. In addition, each of the base games has a different payout rate. Thus, a new entertainment characteristic is real.

### BRIEF DESCRIPTION OF THE DRAWINGS

FIG. 1 is an explanatory diagram of a gaming machine and a playing method thereof, according to a first embodiment of the present invention.

FIG. 2 is a block diagram of the gaming machine.

FIG. 3 is an explanatory diagram of a display state of a base game selection screen.

FIG. 4 is an explanatory diagram of a display state of a base game selection screen.

FIG. 5 is an explanatory diagram of a display screen of a base game.

FIG. 6 is a perspective view of an external appearance of the gaming machine according to the first embodiment.

FIG. 7 is a perspective view of an external appearance of a gaming terminal according to the present invention.

FIG. 8 is a block diagram of an electrical structure of the gaming terminal according to the present invention.

FIG. 9 is a block diagram of an electrical structure of a center controller according to the first embodiment.

FIG. 10 illustrates a gaming terminal management table.

FIG. 11 illustrates a base game data table.

FIG. 12 illustrates a base game payout rate table.

FIG. 13 is a flowchart illustrating a boot process executed in the gaming terminal and the center controller.

FIG. 14 is a flowchart illustrating an initial process executed in the gaming terminal and the center controller.

FIG. 15 is a flowchart illustrating a terminal process routine executed in the gaming terminal.

FIG. 16 is a flowchart illustrating a center process routine executed in the center controller.

FIG. 17 is an explanatory diagram of a gaming system according to a second embodiment.

### DESCRIPTION OF THE PREFERRED EMBODIMENTS

### First Embodiment

The following describes a first embodiment of a gaming machine and a playing method thereof according to the present invention.

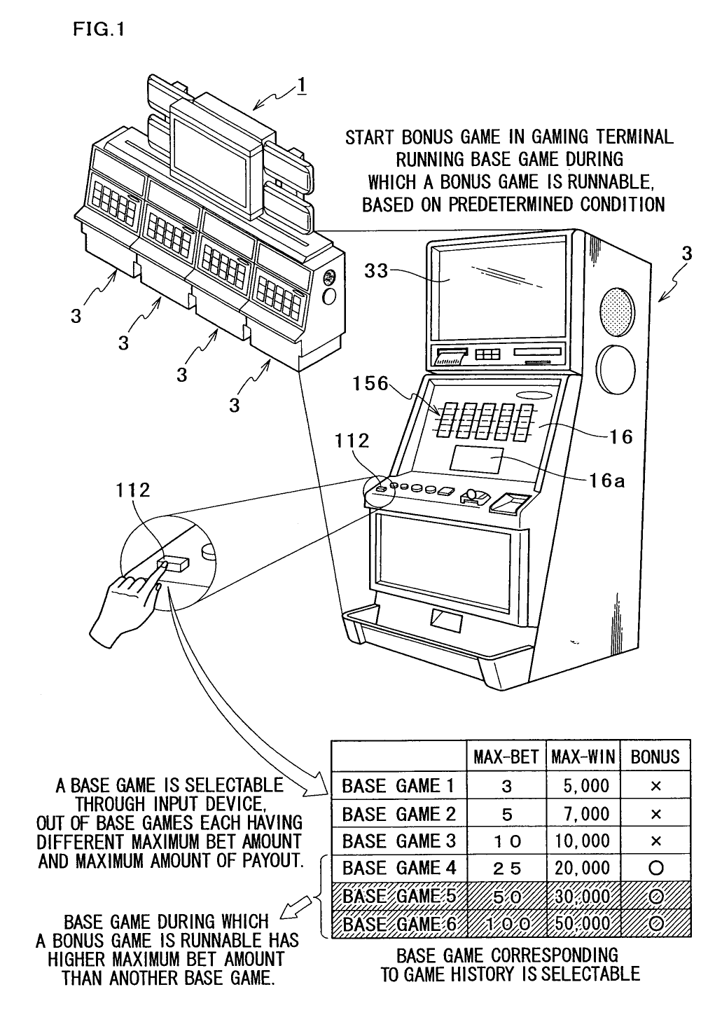

As illustrated in FIG. 1, a gaming machine 1 includes: a plurality of gaming terminals 3 each having an input device 112 through which an input from outside is inputted; a plurality of base games which start in response to a bet within a bettable range determined in advance for each of the base games; and a bonus payout memory 115 which stores a resource for a bonus payout (hereinafter, bonus resource). In each of the gaming terminals 3, the gaming machine 1 realizes a playing method including the steps of: selecting a base game to be run out of the plurality of base games, based on an input through the input device 112; running the base game in response to a bet, independently of another gaming terminal; when the base game is the predetermined base game, permitting a bet within a wider bettable range compared to another base game, and accumulatively storing a part of the bet on the predetermined base game, in the bonus payout memory 115; awarding a payout according to a predetermined winning resulted in the base game, based on a payout rate associated with the base game and a bet on the base game; running a bonus game at a predetermined timing; determining a bonus-winning gaming terminal 3 out of one or more gaming terminals 3 running the predetermined base game, based on a predetermined condition; awarding a bonus payout through the determined gaming terminal 3.

Here, a “base game” is main game which the gaming machine 1 is originally intended for, and which a player mainly plays. A player plays a base game by placing a game value (bet amount) within a predetermined range of amounts (bettable range) as a bet. A payout is awarded when the base game yields a predetermined result. In the present embodiment, a base game is a so-called slot game whose unit game includes variably displaying of symbols and awarding a payout which is awarded only when the symbols stopped form a predetermined winning.

Each of the gaming terminals 3 includes a terminal display 101, a game start unit 110, a bet unit 111, and a terminal controller 100. The terminal display 101 displays one or more base game choices from which a player is allowed to select one. Examples of the terminal display 101 of the present invention includes a liquid crystal display device, CRT (cathode-ray tube) device, a plasma display device, an organic EL (Organic Electro-Luminescence) display device.

The bet unit 111 has functions of receiving a bet entered through an operation by a player, and outputting a bet signal in response to the bet entered. The bet signal output is input to a later-described base game running unit 103. The game starting unit 110 has a function of outputting a game start signal in response to an operation by a player. The game start signal output is then input to a later-described base game running unit 103. The game start unit 110 accepts a start of a game to begin a variable display of a symbol in a base game. In the present embodiment, a variable display of a symbol automatically stops after a predetermined time; however, the structure is not limited to this. For example, a variable display of a symbol may stop in response to an input by a player.

At a time of making a bet on a mass base game, the bet unit 111 permits a bet within a wider bettable range compared to a single base game.

The gaming machine 1 includes a plurality of base games. These base games include a plurality of mass base games. Each of the mass base games is a game during which a player is allowed to participate in a bonus game. Further, any base game other than a mass base game is a single base game during which a player is not allowed to participate in a bonus game. A single base game and a plurality of mass base games are different in maximum bettable amount and maximum payout rate. When comparing a mass base game with a single base game, the maximum bettable amount and maximum payout of the mass base game is higher than those of a single base game.

A “bonus game” is a special game which is simultaneously run, based on a predetermined condition, in one or more gaming terminals 3 running a mass base game. A “bonus game” is also a special game where a payout greater than in a base game is awarded in a gaming terminal 3 when a jackpot is resulted.

Here, a “maximum payout amount” is a maximum amount of payout paid out per unit game. A payout rate is set for each winning for each unit game. A player can obtain a maximum payout amount set for a base game when the player bets a maximum bettable amount and achieves a winning having the maximum payout rate. Note that a part of a bet (e.g., 10% of a bet) is deducted as a resource for a bonus payout in a mass base game. The remaining value of the bet, after the deduction of the part of a player's bet is an actual bet on the mass base game. For example, where an amount bet on a mass base game by a player is one hundred dollars, ten dollars is deducted from the hundred-dollar bet as a resource for a bonus payout and the remaining ninety dollars are allotted as an actual bet amount.

The gaming machine 1 includes three single base games and three mass base games in the present embodiment; however, the gaming machine 1 is not limited to this. For instance, the gaming machine 1 may include one single base game and one mass base game.

All the base games are slot games in the present embodiment; however, a base game is not limited to a slot game. For example, a base game may be a roulette game or a card game such as blackjack. Further, there may be various kinds of base games among the plurality of base games.

As illustrated in FIG. 1, the input device 112 is capable of receiving an input from outside such as a player. The input device 112 is, for example, a button or the like provided to a gaming terminal 3. A player is able to select a base game to be run in a gaming terminal 3 out of the plurality of base games, by operating the input device 112.

Although the input device 112 is a button in the present embodiment, the input device 112 is not limited to this. For example, the input device 112 may be a touch panel provided to a display or the like, or a pointing device such as a mouse.

The bonus payout memory 115 accumulatively stores a resource of a bonus payout which is a value deducted from a player's bet on a mass base game. In other words, a resource for a bonus payout collected from the gaming terminals 3 is accumulatively stored in the bonus payout memory 115. Such a resource for a bonus payout accumulatively stored in the bonus payout memory 115 is hereinafter referred to as a progressive value. That is, in the present embodiment, when a progressive value in the bonus payout memory reaches or exceeds a predetermined amount, a bonus payout including the progressive value is awarded through a gaming terminal 3 where a jackpot is resulted.

The bonus payout memory 115 is provided to a later-described center controller 200 in the present embodiment; however, the structure is not limited to this. For example, the bonus payout memory 115 may be provided to one of the gaming terminals 3.

(Terminal Controller 100)

The terminal controller 100 is configured to execute: a first process of selecting a base game to be run, out of the plurality of base games, based on an input inputted through the input device 112; a second process of running the base game in response to a bet, independently of another gaming terminal; a third process of, when the base game is the predetermined base game, permitting a bet within a wider bettable range compared to another base game, and accumulatively storing a part of the bet on the predetermined base game, in the bonus payout memory 115; a fourth process of awarding a payout according to a predetermined winning resulted in the base game, based on a payout rate associated with the base game and a bet on the base game; a fifth process of awarding a bonus payout based on a command from the center controller 200. In other words, the terminal controller 100 has a first processing unit, a second processing unit, a third processing unit, a fourth processing unit, and a fifth processing unit.

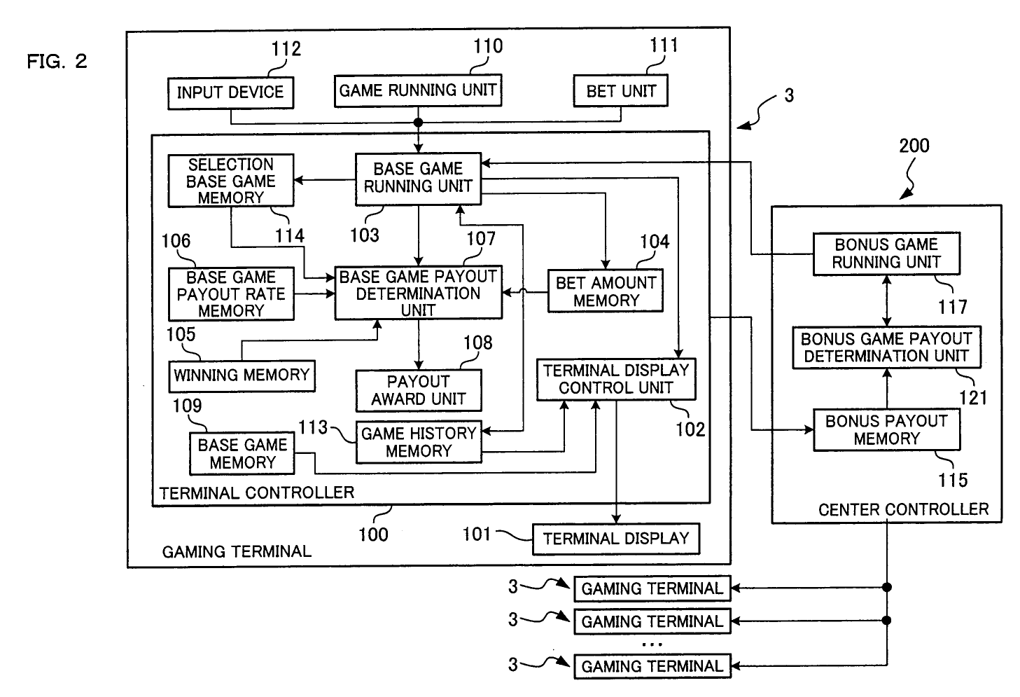

As illustrated in FIG. 2, the center controller 200 is connected to the terminal controller 100 and is in communication with the terminal controller 100. The terminal controller 100 is connected to the game start unit 110, the bet unit 111, and the input device 112.

The terminal controller 100 includes the base game running unit 103, a bet amount memory 104, and a selection base game memory 114. The base game running unit 103 is connected to the input device 112. The base game running unit 103 determines, based on a player's input through the input device 112, which one of the plurality of base games has been selected. Further, the base game running unit 103 determines a bet amount for each unit game based on a player's input into the bet unit 111.

Triggered by a game start signal from the game start unit 110, the base game running unit 103 runs a base game where symbols are variably displayed. A payout is awarded when one or more of the symbols stopped form a predetermined winning. Further, when the base game is a mass game, the terminal controller 100 outputs a progressive signal, triggered by the game start signal. The progressive signal indicates a game value. In other words, a resource for a bonus payout, which is to be deducted, is transmitted to the center controller 200 as a progressive signal when a mass base game is run.

A selection base game memory 114 stores a base game inputted from the input device 112 in the base game running unit 103. In other words, the selection base game memory 114 stores a base game selected by a player.

The bet amount memory 104 stores a bet amount inputted from the bet unit 103 in the base game running unit 103. Note that a part of a player's bet, which remains after deduction of a bonus resource from the player's bet, is stored when a mass base game is selected.

The terminal controller 100 further includes a winning memory 105, abase game payout rate memory 106, abase game payout determination unit 107, and a payout award unit 108.

The winning memory 105 stores a plurality of winnings for a base game. The base game payout rate memory 106 stores a payout rate for each of the winnings set for each of the base games.

The base game payout determination unit 107 determines a payout amount when a variable display of symbols stops. Specifically, the base game payout determination unit 107 determines a payout amount based on: one or more symbols stopped; a running base game stored in the selection base game memory 114; an associated payout rate stored in the base game payout rate memory 106; and a bet amount stored in the bet amount memory 104.

The payout award unit 108 awards a payout to a player based on a payout amount determined by the base game payout determination unit 107. Further, when a jackpot is resulted in a bonus game, the payout award unit 108 awards a bonus payout based on a command from the later-described center controller 200.

The terminal controller 100 further includes a base game memory 109 and a terminal display control unit 102. The base game memory 109 stores a list of base games selectable by a player in a gaming terminal 3. The terminal display control unit 102 causes the terminal display 101 to perform displaying based on the base games stored in the base game memory 109 so as to enable a player to make a selection through the input device 112. A specific display state will be detailed later.

In addition, the terminal controller 100 may include a game history memory 113 which stores a result of a base game as history information. The game history memory 113 stores results of base games (e.g., recently run twenty games) run by the base game running unit 103. Further, when displaying selectable base games, the terminal display control unit 102 may change base games to be displayed, based on game history.

Meanwhile, each block of the terminal controller 100 may be realized with hardware or with software as needed.

(Operation of Terminal Controller 100)

The following describes an operation of the terminal controller 100 in the above structure. First, a base game out of a plurality of base games is inputted into the base game running unit 103 by a player's operation through the input device 112. At this operation, the terminal display 101 is controlled by the terminal display control unit 102 to display a list of selectable base games. The base games displayed may be determined based on game history of one or more past base games stored in the game history memory 113. An inputted base game (hereinafter, referred to as a selected base game) is stored in the selection base game memory 114. Thus, the terminal controller 100 executes the first process of selecting a base game to be run, out of the plurality of base games, based on an input through the input device 112.

Next, a bet amount is inputted into the base game running unit 103 through a player's operation to the bet unit 111. A bet amount inputted is stored in the bet amount memory 104. Then, in response to the player's operation, the game starting unit 110 outputs a game start signal to cause the base game running unit 103 to start a base game. Upon running a base game, selected game and bet amount in a unit game are ultimately determined.

Further, when a selected base game is a mass base game, the terminal controller 100 transmits a part of a player's bet to the center controller 200 as a progressive signal. The progressive signal is accumulatively stored in the bonus payout memory 115 as a progressive value. Thus, the terminal controller 100 executes the third process of, when the base game is a predetermined base game, permitting a bet within a wider bettable range compared to another base game, and accumulatively storing a part of the bet on the predetermined base game, in the bonus payout memory 115.

The base game running unit 103 starts variable displaying of symbols, and stop the variable displaying after elapse of a predetermined time. Variable displaying or still displaying of symbols is not limited to take place on the terminal display 101. It is possible to adopt a mechanical reel or the like, for example. Thus, the terminal controller 100 executes the second process of running the base game in response to a bet, independently of another gaming terminal.

If the terminal controller 100 includes the game history memory 113, the base game running unit 103 stores a result of a base game in the history memory 113.

The base game payout determination unit 107 determines a payout amount awarded to a player, based on a result of one or more symbols stopped. Specifically, the base game payout determination unit 107 compares the result of one or more symbols stopped, and the plurality of winnings stored in the winning memory 105. Further, the base game payout determination unit 107 obtains a selected base game stored in the selection base game memory 114, and obtains, from the base game payout rate memory 106, a payout rate associated with the winning. Further, the base game payout determination unit 107 determines a payout amount by multiplying, by the obtained payout rate, a bet amount stored in the bet amount memory 104. Then, the payout award unit 108 awards a payout to a player, based on the payout amount determined by the base game payout determination unit 107. Thus, the terminal controller 100 executes the fourth process of: awarding a payout according to a predetermined winning resulted in a base game, based on a payout rate associated with the base game and a bet on the base game.

Further, when a jackpot is resulted in a bonus game, the payout award unit 108 awards a bonus payout to a player based on a command from the center controller 200. Thus, the terminal controller 100 executes the fifth process of awarding a bonus payout based on a command from the center controller 200.

(Center Controller 200)

The center controller 200 is configured to execute: a sixth process of running a bonus game at a predetermined timing; a seventh process of, of the gaming terminals 3, selecting a bonus-winning gaming terminal 3 out of one or more gaming terminals 3 running a predetermined base game, based on a predetermined condition; an eighth process of commanding the terminal controller 100 of the determined bonus-winning gaming terminal 3 to award a bonus payout. In other words, the center controller 200 has a sixth processing unit, a seventh processing unit, and a eighth processing unit.

As illustrated in FIG. 2, the center controller 200 is connected to the terminal controller 100 and is in communication with the terminal controller 100.

The center controller 200 includes a bonus game running unit 117, a bonus game payout determination unit 121, and a bonus payout memory 115.

The bonus payout memory 115 accumulatively stores a game value indicated by a progressive signal received from the terminal controller 100. The bonus game running unit 117 runs a bonus game at a predetermined timing. A “predetermined timing” is, for example, when a progressive value stored in the bonus payout memory 115 reaches or exceeds a predetermined amount.

The present embodiment deals with a case where a timing of starting a bonus game is a timing at which a progressive value stored reaches or exceeds a certain amount (e.g., two hundred dollars as a fixed value); however such timing of starting a bonus game is not limited to this. For example, the threshold progressive value where the gaming machine starts running the bonus game may be randomly changed within a predetermined range (e.g., two hundred to three hundred dollars). Further, the threshold progressive value/may be selectable from various values (e.g., two hundred dollars, three hundred dollars, or four hundred dollars) through an input from outside. Further, a bonus game may be started, for example, when a result of a base game in any one of the gaming terminals meets a predetermined condition.

The bonus game payout determination unit 121 determines whether a jackpot is resulted in any one of gaming terminals 3 running a mass base game, and determines a bonus payout amount to be awarded.

Meanwhile, each block of the center controller 200 may be realized with hardware or with software as needed.

(Operation of Center Controller 200)

The following describes an operation of the center controller 200 in the above structure. First, a progressive signal value transmitted from the terminal controller 100 is accumulatively stored in the bonus payout memory 115 as a progressive value. The bonus game running unit 117 starts a bonus game when the accumulatively stored progressive value equals to or exceeds a predetermined amount. Thus, the center controller 200 executes the sixth process of running a bonus game at a predetermined timing.

Of the gaming terminals 3, the bonus game payout determination unit 121 selects a gaming terminal 3 in which a jackpot is to be resulted, out of one or more gaming terminals 3 running a mass base game. The bonus game payout determination unit 121 further determines an amount of a bonus payout. Thus, the center controller 200 executes the seventh process of, of the gaming terminals 3, selecting a bonus-winning gaming terminal 3, out of one or more gaming terminals 3 running a predetermined base game, based on a predetermined condition.

Then, the bonus game running unit 117 transmits a bonus payout signal including information of a bonus payout amount, to the determined gaming terminal 3. Thus, the center controller 200 executes the eighth process of commanding the terminal controller 100 of the determined bonus-winning gaming terminal 3 to award a bonus payout.

As it is obvious from the above operation, the gaming machine 1 realizes a playing method such that a terminal controller 100 carries out the steps of: selecting a base game to be run, out of the plurality of base games, based on an input through the input device 112; running the base game in response to a bet, independently of another gaming terminal; when the base game is the predetermined base game, permitting a bet within a wider bettable range compared to another base game, and accumulatively storing a part of the bet on the predetermined base game, in the bonus payout memory 115; awarding a payout according to a predetermined winning resulted in the base game, based on a payout rate associated with the base game and a bet on the base game; and awarding a bonus payout based on a command from the center controller 200, and that the center controller 200 carries out the steps of: running a bonus base game at a predetermined timing; of the gaming terminals 3, selecting a bonus-winning gaming terminal 3, out of one or more gaming terminals 3 running the predetermined base game, based on a predetermined condition; and commanding the terminal controller 100 of the determined bonus-winning gaming terminal 3 to award a bonus payout.

This can be rephrased as follows. The gaming machine 1 realizes a playing method in each of the plurality of gaming terminals 3, including the steps of: selecting a base game to be run, out of the plurality of base games, based on an input through the input device 112; running the base game in response to a bet, independently of another gaming terminal 3; when a predetermined base game during which a player is allowed to join a bonus game, allowing a bet within a wider bettable range compared to another base game, and accumulatively storing a part of the bet on the predetermined base game, in the bonus payout memory 115; awarding a payout according to a predetermined winning resulted in the base game, based on the payout rate associated with the base game and a bet on the base game; running a bonus game at a predetermined timing; of the gaming terminals 3, selecting a bonus-winning gaming terminal 3, out of one or more gaming terminals 3 running the predetermined base game, based on a predetermined condition; awarding a bonus payout through the determined bonus-winning gaming terminal 3.

According to the playing method, a base game to be run is determined out of the plurality of base games based on an input through the input device 112 in each of the gaming terminals 3. The base game is then run in response to a bet, independently of another gaming terminal. When the base game is the predetermined base game, a bet within a wider bettable range compared to another base game is permitted, and a part of the bet is accumulatively stored in the bonus payout memory 115. Then, a payout according to a predetermined winning resulted in the base game is awarded based on a payout rate associated with the base game and a bet on the base game. Further, a bonus game is run at a predetermined timing. A bonus-winning gaming terminal 3 is selected out of one or more gaming terminals 3 running the predetermined base game, based on a predetermined condition. A bonus payout is awarded through the determined bonus-winning gaming terminal 3.

Thus, the input device 112 enables a player to select a base game out of the plurality of base games. Further, the predetermined base game permits a bet within a wider range compared to another base game. Further, a part of the bet on the predetermined base game is stored in the bonus payout memory 115, and used as a bonus payout in the bonus game. In addition, each base game has a different payout rate. This realizes a new entertainment characteristic.

Further, a result of a base game may be stored in the game history memory 113 as history information at a predetermined timing, and a runnable base game may be determined based on the history information. This further realizes a new entertainment characteristic.

(Display State of Terminal Display 101)

The following details an exemplary display state of a base game selection screen on an upper image display panel 33 as the terminal display 101 during the operations of the gaming machine 1 and the playing method thereof. The base game selection screen is displayed for each unit game.

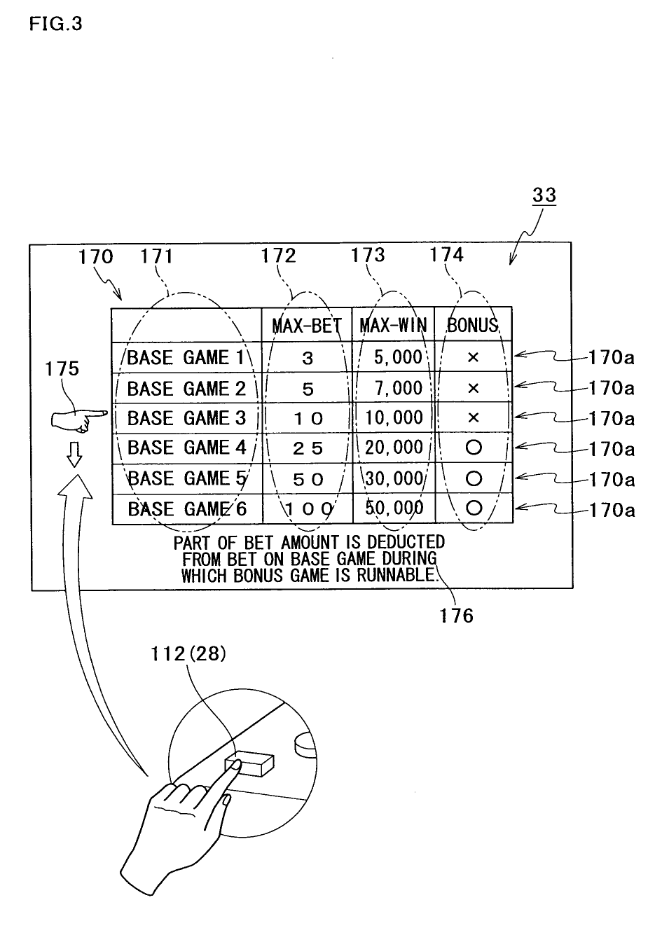

As illustrated in FIG. 3, a base game list image 170 indicating a list of base games from which a player is able to select one, is displayed on the upper image display panel 33 provided to a gaming terminal 3. The base game list image 170 is placed at the center of the upper image display panel 33.

The base game list image 170 has a plurality of base game images 170a. One base game image 170a is placed on top of another. Six base game images 170a are displayed in an example shown in FIG. 3. A base game image 170a has a base game name area 171, a MAX-BET area 172, a MAX-WIN area 173, and a bonus area 174.

Each base game name area 171 displays an image indicating a name of a base game to distinguish each base game. Each MAX-BET area 172 displays an image indicating a maximum bettable amount on each base game. Each MAX-WIN area 173 displays an image indicating a maximum payout amount which is obtained when a maximum bettable amount is bet on each base game. Each bonus area 174 displays an image indicating whether a player is allowed to join a bonus game during the base game. Specifically, when a player is allowed to participate in a bonus game during the base game, a “O” is displayed in the bonus area 174. Meanwhile, when a player is not allowed to participate in a bonus game during the base game, an “X” is displayed in the bonus area 174.

A player is able to select a base game on the base game selection screen by pushing the base game selection button 28 serving as the input device 112 provided to the gaming terminal 3.

Specifically, on the left of the base game list image 170, a base game pointer image 175 is displayed. The base game pointer image 175 is displayed on the left of one of the displayed base game images 170a, so as to indicate that the base game image 170a is selected. The base game pointer image 175 moves sequentially in downward direction from a base game image 170a placed on top, each time a player pushes the base game selection button 28. A player is able to select a desired base game by moving the base game pointer image 175 to point an intended base game.

When a base game during which a bonus game is runnable; i.e., when a mass base game is to be run, a part of a bet is deducted as a bonus resource, and a message 176 is displayed on the upper image display panel 33. For example, as in FIG. 3, the message 176 is a message saying “PART OF BET AMOUNT IS DEDUCTED FROM BET ON BASE GAME DURING WHICH BONUS GAME IS RUNNABLE.”

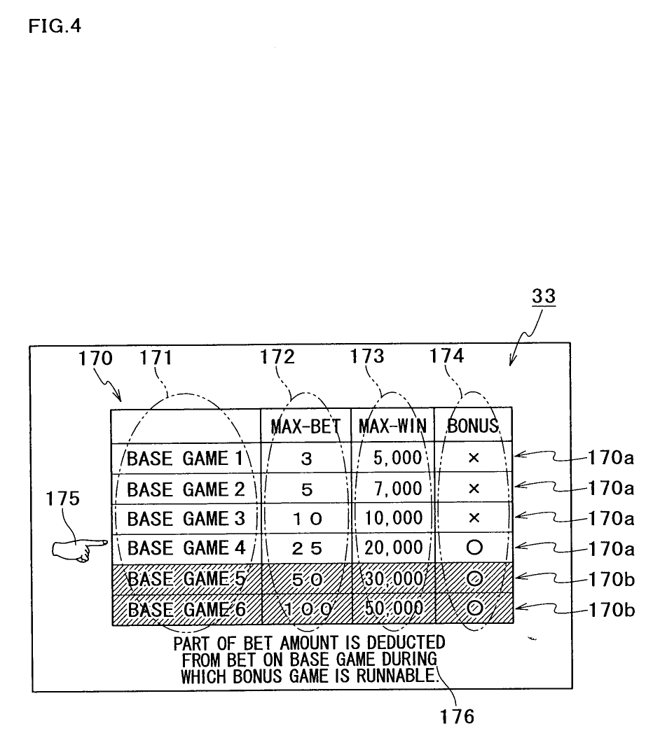

Further, as illustrated in FIG. 4, the base game list image 170 includes base game images 170a, and unselectable base game images 170b. Each unselectable base game image 170b indicates a base game which a player is not allowed to select. A selectable base game is determined based on a result of a past base game (game history). In the present embodiment, a predetermined base game is set as unselectable when there is no payout awarded in the last twenty games. A game set as unselectable is indicated with an unselectable base game image 170b in the base game list image 170. The unselectable base game image 170b is distinguished from a base game image 170a by graying out the background of the image. Note that the base game pointer image 175 is configured not to point at the unselectable base game image 170b even when a player pushes the base game selection button 28.

Note that displaying state of the base game selection screen is not limited to the above. For instance, an unselectable base game may be undisplayed. Further, how to select a base game is not limited to the above method. For example, a base game may be selected by lot or the like, so that a player would not know which base game s/he would be given to play. Alternatively, for instance, a base game may be randomly determined based on a press operation to the base game selection button 28.

(Running Base Game)

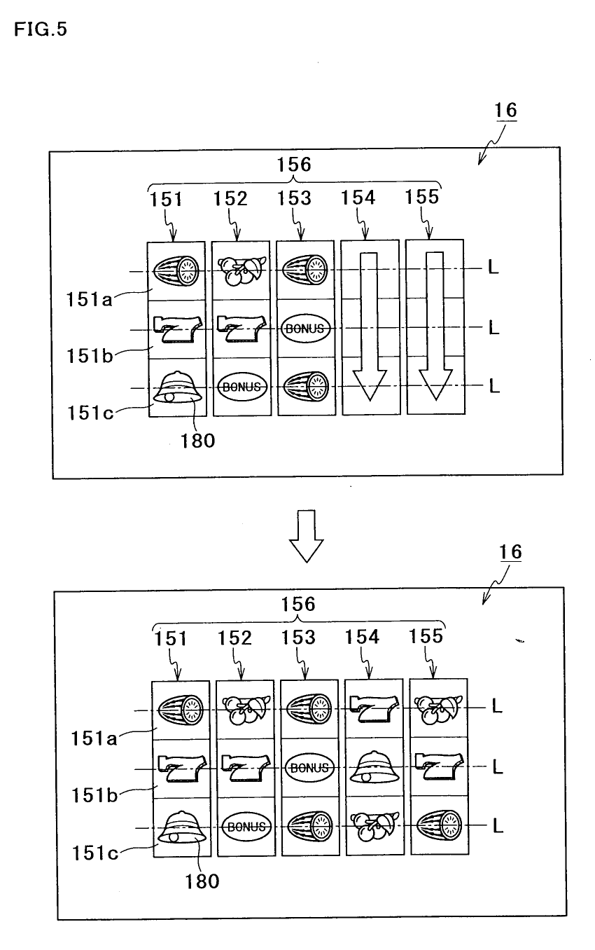

The following details an example of a base game of the gaming machine 1 and the playing method thereof. The following description is based on a structure where one or more symbols are arranged with a video reel on the lower image display panel 16 provided to the gaming terminal 3, as illustrated in FIG. 5.

A matrix 156 is placed at the center of the lower image display panel 16. In the matrix 156, a symbol column having symbols 180 is scrolled to variably display the symbols 180. The display windows 151 to 155 are respectively divided into upper stages 151a to 155a, central stages 151b to 155b, and lower stages 151c to 155c. The symbols 180 are stopped (arranged) in the stages 151a to 155a, 151b to 155b, and 151c to 155c, respectively, thus a variable display of symbols 180 stops. For example, in FIG. 5, a “WATERMELON” is stopped in 151a of the upper stage of the display window 151, a “7” is stopped in 152b of the central stage of the display window 152 and another “WATERMELON” is stopped in 153c of the lower stage of the display window 153. In short, the matrix 156 is a symbol matrix including five columns/three rows. The matrix 156 however is not limited to the one with the five column/three rows.

The terminal display 101 variably displays symbols 180 when a base game is started in the gaming terminal 3. When this variable displaying of symbols 180 stops, symbols 180 are rearranged in the arrangement areas 150, as illustrated in the lower part of FIG. 5. Then, a payout according to a relation among the symbols 180 rearranged is awarded.

(Symbol, Combination, or the Like)

A terminal display 101 has a matrix 156 including symbol columns each having twenty two symbols 180. To each of the symbols constituting the symbol columns is given one of code numbers 0 to 21. Each symbol column has a combination of symbols of “BELL,” “APPLE,” “7,” “WATERMELON,” “CHERRY,” AND “BONUS.”

Of the symbols in the symbol columns, the display windows 151 to 155 each displays (arranges) three successive symbols. The symbols arranged in the upper stages 151a to 155a, the central stages 151b to 155b, and the lower stages 151c to 155c form a symbol matrix having five columns and three rows. When a bet button and a start button are sequentially pushed in this order to start a game, symbols constituting the symbol matrix start scrolling. This scrolling of the symbols stops (rearrangement) after a predetermined period from the beginning of the scrolling.

Further, “winning” refers to a predetermined combination of symbols in the present embodiment. A player is put in an advantageous position when a predetermined winning is displayed on a payline. For example, the advantages include: a state where the number of coins corresponding to the winning are paid out, a state where the number of coins to be paid out is added to a credit, a state where a second game is started. It should be noted that a winning is not particularly limited to a combination of symbols. A winning may be a combination of cards in a poker game, or a number on a roulette wheel, for example.

A second game may be triggered when three or more symbols of “BONUS” are rearranged in the matrix 156, and the gaming state moves from a base game to a second game which is more advantageous than the base game.

In addition, for example, the second game may be a free game. The free game is a game allowing a player to play a game for a predetermined number of times without betting a coin. No particular limitation is put on the second game, as long as it is a gaming state advantageous to the player, that is, it is more advantageous than the base game. For example, the second game may include a state where more game media are obtainable than in the base game, a state where a game medium is obtainable with higher probability than in the base game, a state where a fewer game media are consumed than in the base game, or the like. Specifically, a free game and a feature game or the like may be mentioned as examples of the second game.

(Mechanical Structure of Gaming Machine 1)

Next, the following describes a specific example of mechanical and electrical structures of the gaming machine 1 thus structured.

A gaming machine 1 is placed in a gaming facility such as a casino. This gaming machine 1 runs a unit game which involves a game medium. The game medium is a coin, bill, or a value in the form of electronic information. However, the game medium in the present invention is not particularly limited. For example, a medal, a token, electronic money, a ticket or the like are also possible. Further, the ticket is not particularly limited and may be a later-described ticket with a barcode or the like ticket.

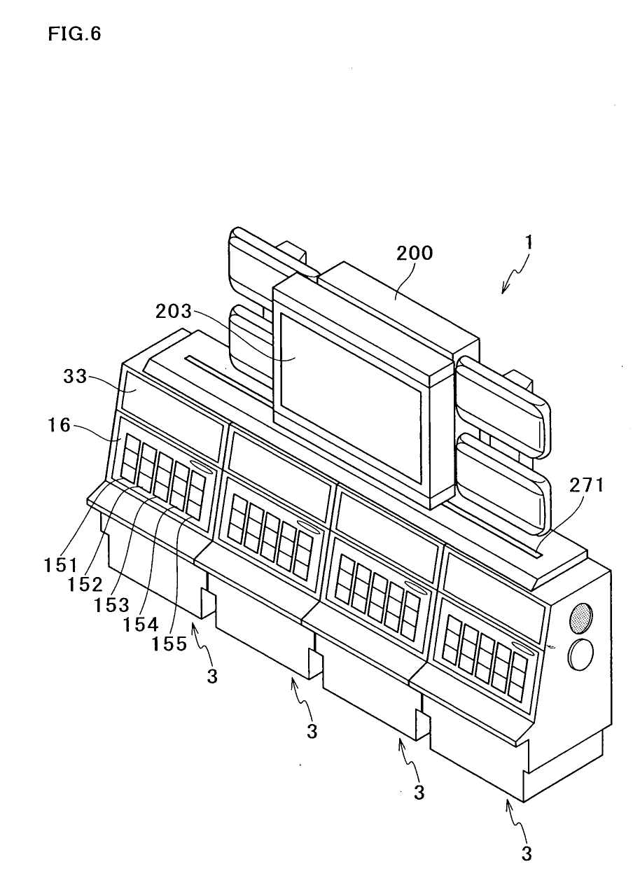

As illustrated in FIG. 6, the gaming machine 1 includes: gaming terminals 3 which run a game independently of one another; a center controller 200 connected to the gaming terminals 3, which is in communication with the gaming terminals 3, and runs a shared game; a shared display 201 which displays thereon an effect image related to the shared game; a rail 271 which supports the shared display 201 and allows the shared display 201 to move to a position directly above the gaming terminals 3; and a not-shown drive motor 270 which enables the shared display 201 to move along the rail 271.

Although it is not illustrated, the shared display 201 is configured to display an image indicating a current progressive value, and an effect image in a bonus game, or the like.

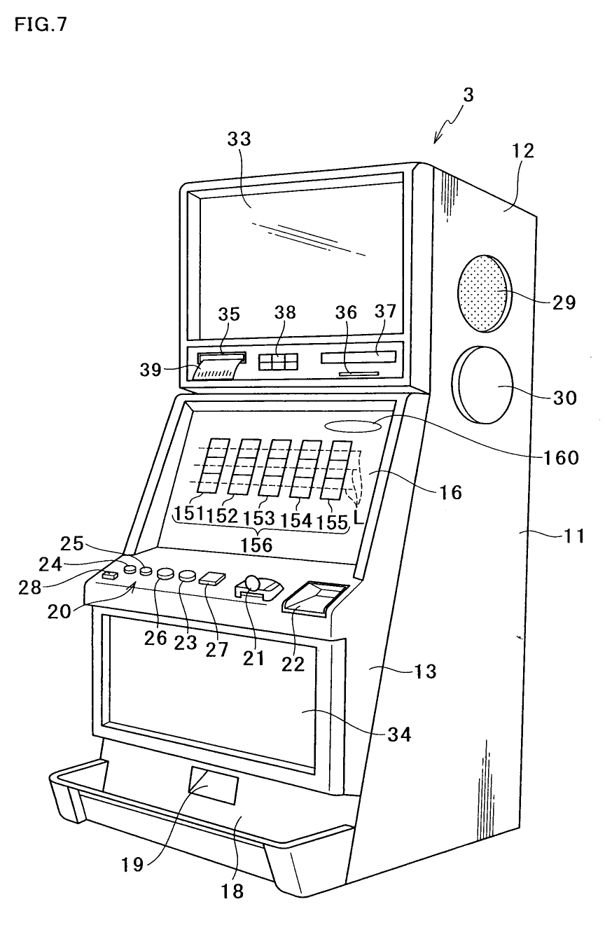

As illustrated in FIG. 7, the gaming terminal 3 includes: a cabinet 11, a top box 12 provided above the cabinet 11, and a main door 13 provided on the front surface of the cabinet 11. The main door 13 has a lower image display panel 16. The lower image display panel 16 has a transparent liquid crystal panel for displaying various kinds of information. The lower image display panel 16 displays display windows 151 to 155 and a matrix 156 for arranging therein symbols 180. Further, the lower image display panel 16 displays as needed various kinds of information and effect images related to a game.

The present embodiment deals with a case where the lower image display panel 16 electrically displays symbols 180 arranged in five rows/three columns. However, the present invention is not limited to this.

The lower image display panel 16 displays three activated paylines L. Note that the number of pay lines L may be one, or four or more. When the number of pay lines L is four or more, the number of pay lines L to be activated may be determined according to a predetermined condition, such as the number of coins placed as a bet.

Note that the lower image display panel 16 may have a credit value indicator and a payout value indicator. The credit value indicator displays a total value (hereinafter also referred to as total credit value) which a gaming terminal 3 can pay out to a player. When symbols stopped along a pay line L form a winning combination, the payout value indicator displays the number of coins to be paid out.

Further, a scatter symbol may be adopted, and the number of coins to be paid out may be determined, according to the number of scatter symbols displayed on the matrix 156. Note that the pay line L does not necessarily have to be displayed.

Below the lower image display panel 16 provided are a control panel 20, a coin insertion slot 21, and a bill validator 22. The control panel 20 has buttons 23 to 28 provided so as to enable an input from outside. These buttons 23 to 28 allow a player to input instructions related to a game played by the player. Through the coin insertion slot 21, a coin is received in the cabinet 11.

The control panel 20 has: a spin button 23, a change button 24, a cashout button 25, a 1-bet button 26, a maximum bet button 27, and a base game selection button 28. The spin button 23 is for inputting an instruction to start symbol scrolling. The change button 24 is used to ask a staff in the gaming facility for change of money. The cash out button 25 is for inputting an instruction to pay out coins corresponding to the total credit-value into the coin tray 18.

The 1-bet button 26 is used for betting one coin out of those corresponding to the total credit value. The maximum bet button 27 is used for betting, out of those corresponding to the total credit value, a maximum number of coins (e.g., fifty coins) which can be bet in one game.

Each base game has a different maximum number of coins bettable (maximum bettable amount) per unit game. A base game is determined when a player pushes the maximum bet button 27, and a maximum bettable amount set for the base game is inputted. The base game selection button 28 is for inputting a base game which a player desires to select, on the base game selection screen.

The bill validator 22 validates whether a bill is genuine or not and receives the genuine bill into the cabinet 11. Note that the bill validator 22 is capable of reading a barcode attached to a later-mentioned ticket 39 having a bar-code (hereinafter simply referred to as ticket 39). When the bill validator 22 reads the ticket 39, it outputs to the main CPU 41 a read signal representing information having read from the barcode.

On the lower front surface of the main door 13, that is, below the control panel 20, a belly glass 34 is provided. On the belly glass 34, a character of a gaming terminal 3 or the like is drawn. On the front surface of top box 12 is provided an upper image display panel 33. The upper image display panel 33 has a liquid crystal panel and displays an effect image, introduction to the game, rules of the game, or the like.

Further, the top box 12 has a speaker 29 for performing an audio output. Below the upper image display panel 33 are provided a ticket printer 35, a card reader 36, a data displayer 37, and a keypad 38. The ticket printer 35 prints, on to a ticket, a barcode having encoded data containing credit-value, date and time, identification number of a gaming terminal 3 or the like, thereby issuing a ticket 39 having a barcode attached thereto. A player can play a game in another gaming terminal 3 with the ticket 39 having the barcode, or exchange the ticket 39 having the barcode with bill at a change booth of the game arcade.

The card reader 36 reads/writes data from/into a smart card. The smart card is carried by a player, and stores therein data for identifying the player, data relating to a history of games played by the player, or the like.

The data displayer 37 includes a fluorescent display or the like, and displays the data read by the card reader 36 and the data input by the player through the keypad 38. The keypad 38 is for entering instructions or data relating to issuing of a ticket or the like.

(Electrical Structure of Gaming Machine 1)

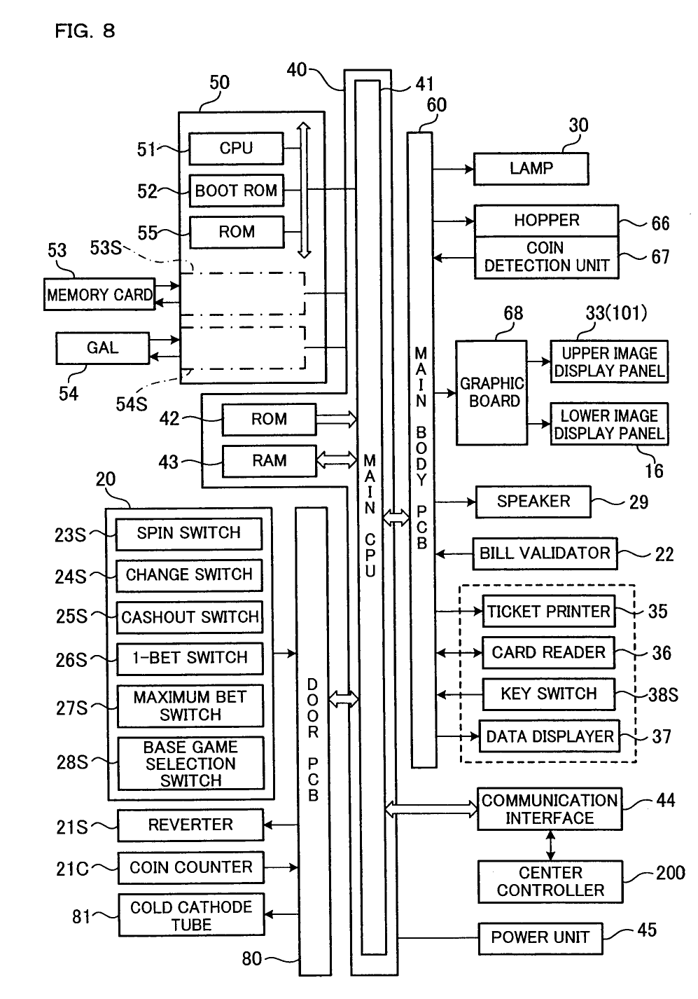

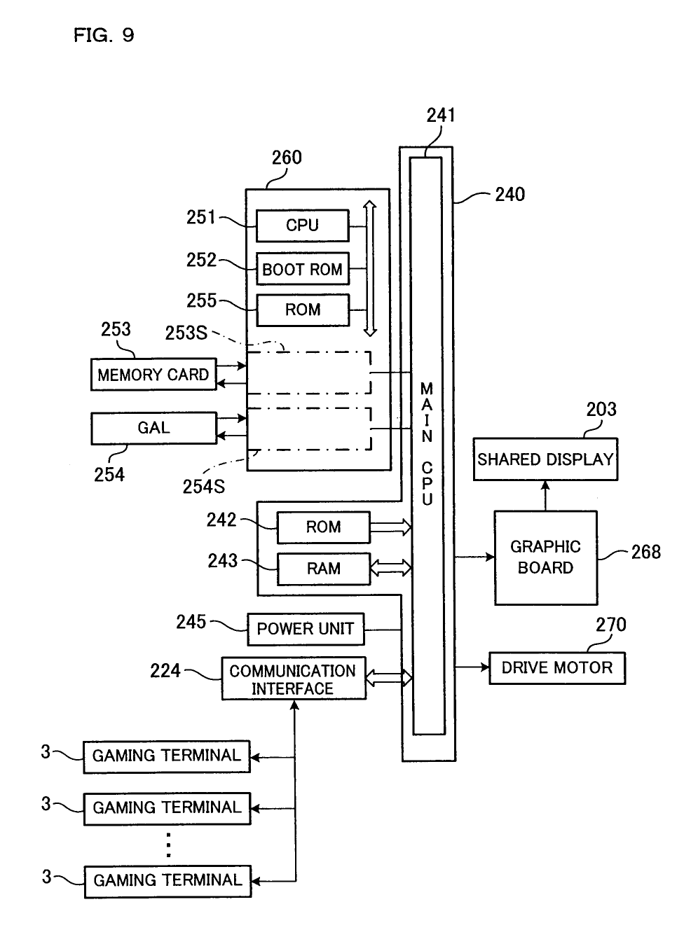

FIGS. 8 and 9 are block diagrams each illustrating an electrical structure of the entire gaming machine 1.

(Electrical Structure of Gaming Terminal 3)

FIG. 8 is a block diagram illustrating an electrical structure of the entire gaming terminal 3. As illustrated in FIG. 8, the cabinet 11 includes a control unit having a terminal controller 100. As illustrated in FIG. 8, the control unit includes a motherboard 40, a main body PCB (Printed Circuit Board) 60, a gaming board 50, a door PCB 80, various switches, sensors, or the like.

The gaming board 50 is provided with a CPU (Central Processing Unit) 51, a ROM 55, a boot ROM 52, a card slot 53S corresponding to a memory card 53, and an IC socket 54S corresponding to a GAL (Generic Array Logic) 54. The CPU 51, the ROM 55, and the boot ROM 52 are connected to one another through an internal bus.

The memory card 53 stores therein a game program and a game system program. The game program contains a stop symbol determining program. The stop symbol determining program determines symbols (code number corresponding to the symbol) to be stopped in the arrangement areas 150. This stop symbol determining program contains sets of symbol weighting data respectively corresponding to various payout rates (e.g., 80%, 84%, 88%). Each set of the symbol weighting data indicates, for each of the display windows 151 to 155, a code number of each symbol and at least one random numerical value allotted to the code number. The numerical value is a value within a predetermined range of 0 to 256 for example.

The payout rate is determined based on payout rate setting data output from the GAL 54. Based on a set of the symbol weighting data corresponding to the payout rate determined, a symbol to be stopped is determined.

The memory card 53 stores therein various types of data for use in the game programs and the game system programs. For example, the memory card 53 stores a table listing combinations of symbols 180 to be displayed on the display windows 151 to 155 of FIG. 5 and an associated range of random numerical values. This data is transferred to the RAM 43 of the motherboard 40, at the time of running a game program.

The card slot 53S is structured so as to allow the memory card 53 to be attached/detached to/from the card slot 53S. This card slot 53S is connected to the motherboard 40 through an IDE bus. Thus, the type and content of a game run by a gaming terminal 3 can be modified by detaching the memory card 53 from the card slot 53S, write a different game program and a different game system program into the memory card 53, and inserting the memory card 53 back into the card slot 53S.

Each of the game programs includes a program related to the progress of the game and/or a program for causing a transition to a bonus game. Each of the game programs includes image data and audio data output during the game.

The GAL 54 has input and output ports. When the GAL 54 receives data via an input port, it outputs data corresponding to the input data from its output port. This data from the output port is the payout rate setting data described above.

The IC socket 54S is structured so as to allow the GAL 54 to be attached/detached to/from the IC socket 54S. The IC socket 54S is connected to the motherboard 40, via a PCI bus. Thus, the payout rate setting data to be output from GAL 54 can be modified by: detaching the GAL 54 from the IC socket 54S, overwriting the program stored in the GAL 54, and attaching the GAL 54 back to the IC socket 54S.

The CPU 51, the ROM 55 and the boot ROM 52 connected through an internal bus are connected to the motherboard 40 through the PCI bus. The PCI bus communicates signals between the motherboard 40 and the gaming board 50 and supplies power from the motherboard 40 to the gaming board 50. The ROM 55 stores country identification information and an authentication program. The boot ROM 52 stores a preliminary authentication program and a program (boot code) for enabling the CPU 51 to run the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication program to be authenticated is not falsified. In short, the preliminary authentication program authenticates the authentication program.

The motherboard 40 is provided with a main CPU 41 (terminal controller 100), a ROM (Read Only Memory) 42, a RAM (Random Access Memory) 43, and a communication interface 44.

The main CPU 41 serves as a terminal controller 100 and has a function of controlling the entire gaming terminal 3. In particular, the main CPU 41 controls the following operations: an operation of outputting a command signal instructing variable-displaying of symbols 180 to the graphic board 68, which is performed in response to pushing of the spin button 23 after betting of credit; an operation of determining symbols 180 to be stopped after the variable-displaying of symbols 180; and an operation of stopping the symbols 180 thus determined in the display window 151 to 155.

In other words, the main CPU 41 serves as an arrangement controller which arranges symbols to form a new symbol matrix through scrolling of symbols displayed on the lower image display panel 16. This main CPU 41 therefore determines symbols to be rearranged in a symbol matrix by selecting symbols to be rearranged from various kinds of symbols. Then, the main CPU 41 executes arrangement control to stop scrolling the symbols to present the symbols thus determined.

The ROM 42 stores a program such as BIOS (Basic Input/Output System) run by the main CPU 41, and permanently-used data. When the BIOS is run by the main CPU 41, each of peripheral devices is initialized and the game program and the game system program stored in the memory card 53 are read out through the gaming board 50. The RAM 43 stores data or a program used for the main CPU 41 to perform a process.

The communication interface 44 is provided to communicate with a host computer or the like equipped in the gaming facility, through the network (communication line) The communication interface 44 is also for communicating with the center controller 200 through a communication line. /Further, a main body PCB (Printed Circuit Board) 60 and a door PCB 80 are connected to the motherboard 40, through USB (Universal Serial Bus). Further, the motherboard 40 is connected to a power unit 45. The power unit 45 supplies power to the motherboard 40 to boot the main CPU 41 thereof. Meanwhile, the power unit 45 supplies power to the gaming board 50 through the PCI bus to boot the CPU 51 thereof.

The main body PCB 60 and door PCB 80 are connected to various devices or units which generate signals to be input to the main CPU 41, and various devices or units whose operations are controlled by signals from the main CPU 41. Based on a signal input to the main CPU 41, the main CPU 41 runs the game program and the game system program stored in the RAM 43, to perform an arithmetic process. Then, the CPU 41 stores the result of the arithmetic process in the RAM 43, or transmits a control signal to the various devices and units to control them based on the result.

The main body PCB 60 is connected with the lamp 30, a hopper 66, a coin sensor 67, the graphic board 68, the speaker 29, the bill validator 22, the ticket printer 35, the card reader 36, a key switch 38S, and the data displayer 37.

The lamp 30 is turned on/off on the basis of a control signal from the main CPU 41.

The hopper 66 is mounted in the cabinet 11 and pays out a predetermined number of coins from a coin outlet 19 to the coin tray 18, based on a control signal from the main CPU 41. The coin sensor 67 is provided inside the coin outlet 19, and outputs a signal to be input to the main CPU 41 upon sensing that a predetermined number of coins have been delivered from the coin outlet 19.

The graphic board 68 controls image displaying of the upper image display panel 33 and the lower image display panel 16, based on a control signal from the main CPU 41. Further, the graphic board 68 is provided with a VDP (Video Display Processor) for generating image data on the basis of a control signal from the main CPU 41, a video RAM for temporarily storing the image data generated by the VDP, or the like. Note that image data used at the time of generating the image data by the VDP is in a game program which is read out from the memory card 53 and stored in the RAM 43.

The bill validator 22 reads an image on a bill and takes only those recognized as genuine into the cabinet 11. When taking in a genuine bill, the bill validator 22 outputs an input signal indicating the value of the bill to the main CPU 41. The main CPU 41 stores into the RAM 43 a credit-value corresponding to the value of the bill indicated by the signal.

The ticket printer 35 prints a barcode on to a ticket to issue a ticket 39 having the barcode. The barcode contains encoded data such as credit-value stored in the RAM 43, date and time, identification number of the gaming terminal 3, or the like, based on a control signal from the main CPU 41.

The card reader 36 reads out data from the smart card and transmits the data to the main CPU 41. Further, the card reader 36 writes data into the smart card based on the control signal output from the main CPU 41. The key switch 38S is mounted to the keypad 38, and outputs a signal to the main CPU 41 in response to an operation of the keypad 38 by the player. The data displayer 37 displays, based on a control signal from the main CPU 41, the data read by the card reader 36 or the data input by the player through the keypad 38.

The door PCB 80 is connected to the control panel 20, a reverter 21S, a coin counter 21C, and a cold cathode tube 81. The control panel 20 is provided with: a spin switch 23S associated with the spin button 23; a change switch 24S associated with the change button 24; a cashout switch 25S associated with the cashout button 25; a 1-bet switch 26S associated with the 1-bet button 26; a maximum bet switch 27S associated with the maximum bet button 27; and a base game selection switch 28S associated with the base game selection button 28. Each of the switches 23S to 28S outputs a signal to the main CPU 41, when a player pushes the associated buttons 23 to 28.

The coin counter 21C is provided within the coin insertion slot 21, and identifies whether the coin inserted into the coin insertion slot 12 by the player is genuine. Anything other than a genuine coin is discharged from the coin outlet 19. In addition, the coin counter 21C outputs an input signal to the main CPU 41 upon detection of a genuine coin.

The reverter 21S is operated on the basis of the control signal output from the main CPU 41 and distributes a coin recognized as genuine by the coin counter 21C, to a not-shown cash box or hopper 66 mounted in the gaming terminal 3. In other words, when the hopper 66 is full of coins, a genuine coin is distributed into the cash box by the reverter 21S. On the other hand, when the hopper 66 is not yet full of coins, the genuine coin is distributed into the hopper 66. The cold cathode tube 81 functions as a backlight mounted to rear sides of the lower image display panel 16 and the upper image display panel 33. This cold cathode tube 81 turns on according to a control signal from the main CPU 41.

(Electrical Structure of Center Controller 200)

FIG. 9 is a block diagram illustrating an electrical structure of the center controller 200. The center controller 200 is provided therein with a control unit. As illustrated in FIG. 9, the control unit includes a motherboard 240, a gaming board 260, an actuator, or the like.

The gaming board 260 has the same structure as that of the gaming board 50. The motherboard 240 has the same structure as that of the motherboard 40. The communication interface 244 communicates with the terminal controller 100 of each of the gaming terminals 3 through a communication line.

The graphic board 268 has the same structure as that of the graphic board 68, except in that the graphic board 268 controls image displaying of the shared display 201 based on a control signal from the main CPU 241.

The drive motor 270 is a stepping motor and is connected to a not-shown drive wheel. The drive motor 270 is driven by a control signal from the main CPU 241, and rotates the drive wheel to move the shared display 201.

(Gaming Terminal Management Table)

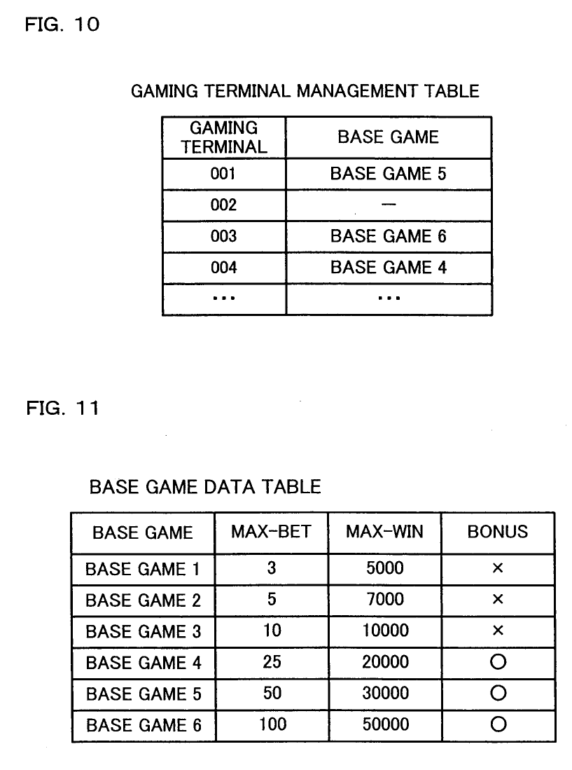

FIG. 10 is a gaming terminal management table. The gaming terminal management table is stored in a RAM 243 of the center controller 200. The gaming terminal management table stores types of mass base games running in each of the gaming terminals 3, associating with each of the gaming terminals 3. The gaming terminal management table is updated by transmitting a mass base game signal, which indicates a mass base game to be run, to the center controller 200 each time a mass base game is started in each of the gaming terminals 3.

For example, in FIG. 10, the gaming terminal management table indicates that base game 5 is running in the gaming terminal 3 corresponding to “001,” no mass base game is running in the gaming terminal 3 corresponding to “002,” base game 6 is running in the gaming terminal 3 corresponding to “003,” and base game 4 is running in the gaming terminal corresponding to “004.”

(Base Game Data Table)

FIG. 11 illustrates a base game data table. The base game data table is stored in the ROM 42 of a gaming terminal 3. The base game data table stores a maximum bettable amount on each of the base games, and information on whether a bonus game is runnable (i.e., whether the base game is a mass base game). The base game data table is referred to at a time of displaying the base game selection screen. Further, the base game data table is referred to when the maximum bet button 27 is pushed.

Comparing the maximum bettable amount and the maximum payout amount of a mass base game (base games 4 to 6) during which a bonus game is runnable and those of a single base game during which no bonus game is runnable, the former are set higher than the latter, as illustrated in FIG. 11. In short, a mass base game permits a bet within a wider bettable range compared to that of a bet on a single base game.

(Base Game Payout Rate Table)

FIG. 11 is a base game payout rate table. The base game payout rate table is stored in the ROM 42 of the gaming terminal 3. The base game payout rate table stores a payout rate for each winning results in the base games. The base game payout rate table is referred to at a time of determining a payout amount of a base game.

For instance, when Base Game 1 is run and a winning includes a symbol of “WATERMELON,” the payout rate is seventeen. Thus, if a three-dollar bet is placed on Base Game 1, the payout is fifty-one dollars. Likewise, when Base Game 6 is run and a winning includes a symbol of “BELL,” the payout rate is ten. Thus, if a hundred-dollar bet is placed on Base Game 6, 10% of the bet is deducted as a resource for a bonus payout, leaving a payout of ninety dollars.

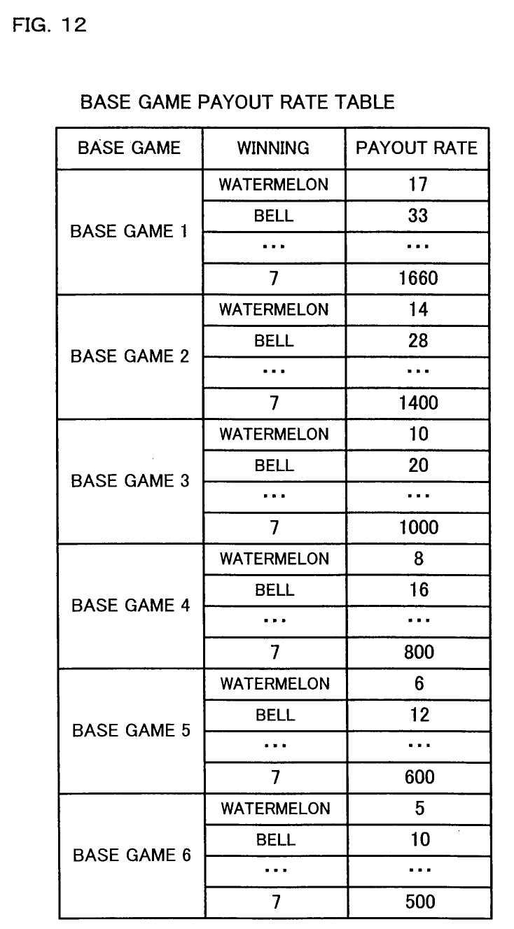

Comparing (i) a payout rate of a winning in a mass base game (base games 4 to 6) during which a bonus game is runnable with (ii) that of the same winning in a single base game during which no bonus game is runnable, the former is set lower than the latter, in the present embodiment, as illustrated in FIG. 12. However, the setting of the payout rate is not limited to this.

(Operation of Gaming Machine 1: Boot Process)

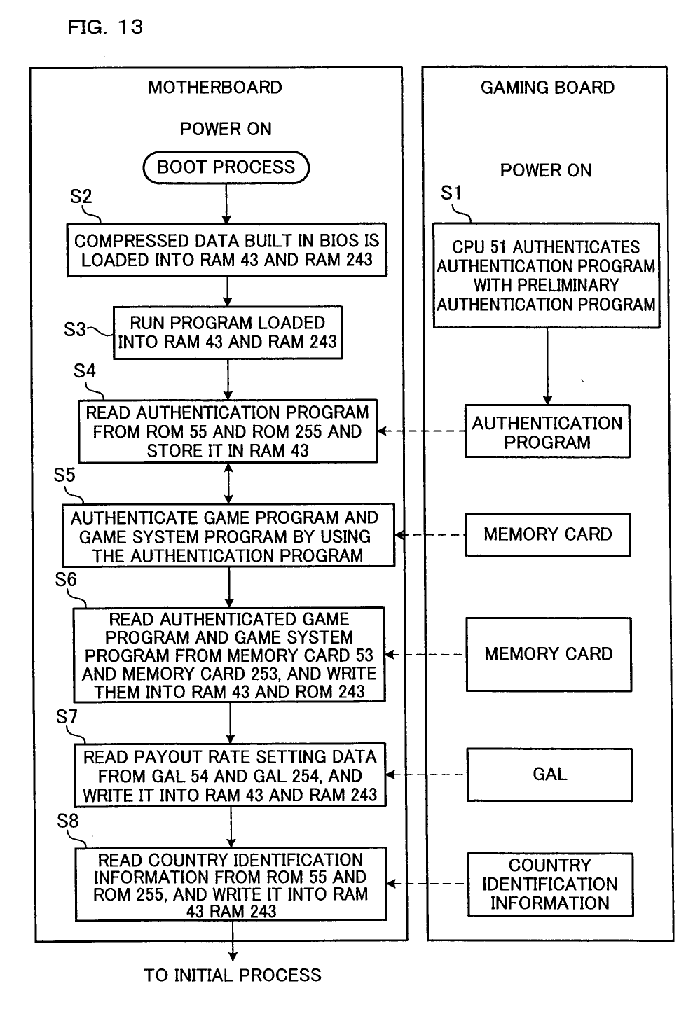

The following describes a boot process routine which takes place in the gaming machine 1. Upon powering on the gaming machine 1, a boot process routine illustrated in FIG. 13 starts in: the mother board 240 and gaming board 260 in the center controller 200, and in the mother board 40 and the gaming board 50 in the terminal controller 100. The memory cards 53 and 263 are assumed to be inserted into the card slots 53S and 263S of the gaming boards 50 and 260, respectively. Further, the GAL 54 and 264 are assumed to be attached to the IC socket 54S and 264S, respectively.

First, turning on the power switch of (powering on) the power units 45 and 245 boots the motherboards 40 and 240, and the gaming boards 50 and 260. Booting the motherboards 40 and 240 and the gaming boards 50 and 260 starts separate processes in parallel. Specifically, the CPUs 51 and 261 read out preliminary authentication programs stored in the boot ROMs 52 and 262, respectively. Then, preliminary authentication is performed according to the read out programs so as to confirm and verify that no falsification is made to authentication programs, before reading them in the motherboards 40 and 240, respectively (S1). Meanwhile, the main CPUs 41 and 241 of the motherboards 40 and 240 run BIOS stored in the ROMs 42 and 242 to load into the RAMs 43 and 243 compressed data built in the BIOS, respectively (S2). Then, the main CPUs 41 and 241 run a procedure of the BIOS according to the data loaded into the RAMs 43 and 243 so as to diagnose and initialize various peripheral devices (S3).

The main CPUs 41 and 241, which are respectively connected to the ROMs 55 and 265 of the gaming boards 50 and 260 via PCI buses, read out authentication programs stored in the ROMs 55 and 265 and stores them in the RAMs 43 and 243 (S4). During this step, the main CPUs 41 and 241 each derives a checksum through ADDSUM method (a standard check function) which is adopted in a standard BIOS, and store the authentication programs into RAMs 43 and 243 while confirming if the operation of storing is carried out without an error.

Next, the main CPUs 41 and 241 each checks what connects to the IDE bus. Then, the main CPUs 41 and 241 access, via the IDE buses, to the memory cards 53 and 263 inserted into the card slots 53S and 263S, and read out game programs and game system programs from the memory cards 53 and 263, respectively. In this case, the CPUs 41 and 241 each reads out four bytes of data constituting the game program and the game system program at one time. Next, the CPUs 41 and 241 authenticate the game program and the game system program read out to confirm and verify that these programs are not falsified, following the authentication program stored in the RAMs 43 and 243 (S5).

When the authentication properly ends, the main CPUs 41 and 241 write and store the authenticated game programs and game system programs in RAMs 43 and 243 (S6).

Next, the main CPUs 41 and 241 access, via the PCI buses, to the GALs 54 and 264 attached to the IC socket 54S•264S, and read out payout rate setting data from the GALs 54 and 264, respectively. The payout rate setting data read out is then written and stored in the RAMs 43 and 243 (S7).

Next, the main CPUs 41 and 241 read out, via the PCI buses, country identification information stored in the ROMs 55 and 265 of the gaming boards 50 and 265, respectively. The country identification information read out is then stored in the RAMs 43 and 243 (S8).

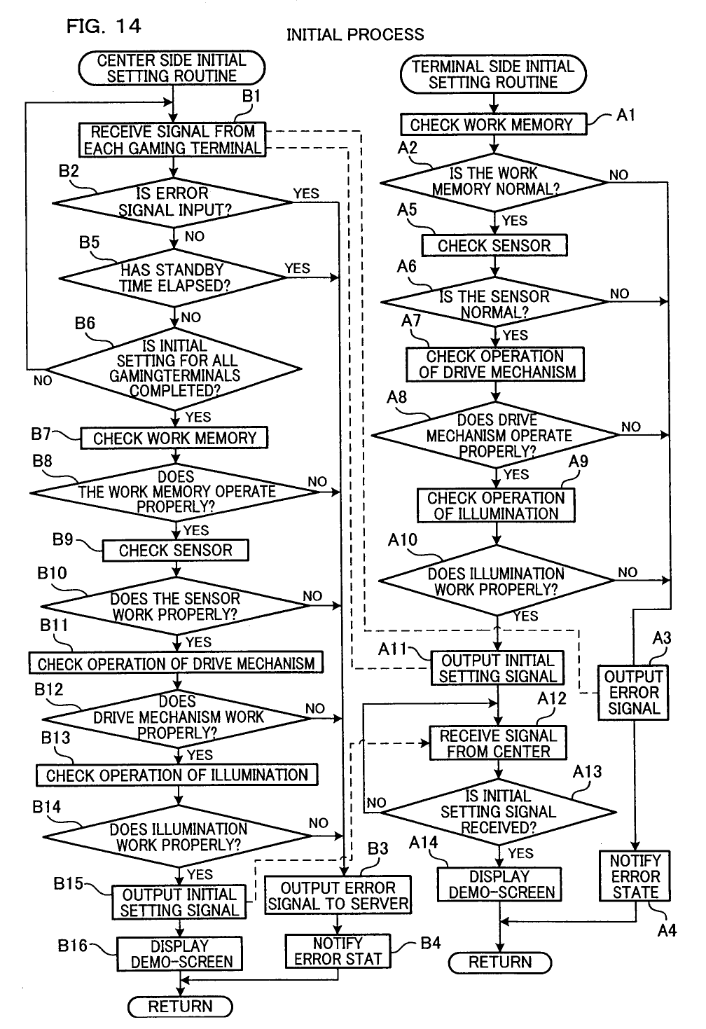

After this, the main CPU 41 and 241 each performs an initial process of FIG. 14.

(Operation of Gaming Machine 1: Initial Process)

The following describes an initial process which takes place in the gaming machine 1. When the boot process of FIG. 13 is completed, the center controller 200 reads out from the RAM 243 a center side initial setting routine illustrated in FIG. 14 and executes the routine. Meanwhile, the gaming terminal 3 reads out from the RAM 43 a terminal side initial setting routine illustrated in FIG. 13 and executes the routine. The center side and terminal side initial setting routines are executed in parallel.

First, the main CPU 41 of each of the gaming terminals 3 checks operations of work memories such as the RAM 43, various sensors, and various decorative illuminations (A1). Then, the main CPU 41 determines if all the check results are normal (A2). If the main CPU 41 determines that the check results contains an error (A2: NO), the main CPU 41 outputs a signal notifying the error (hereinafter, error signal) to the center controller 200 (A3). Further, the main CPU 41 reports the error in the form of illuminating the lamp 30 or the like (A4), and then ends the routine.

On the other hand in A2, if the main CPU 41 determines that all the check results are normal (A2: YES), an initial setting signal is output to the center controller 200 (AS). Then, an initial setting signal is waited from the center controller 200 (A6, A7: NO).

The main CPU 241 of the center controller 200 receives signals from each of the terminals (B1). Then, the main CPU 241 determines whether a signal received is an error signal (B2) If the main CPU 241 determines that the signal is an error signal (B2: YES), the main CPU 241 outputs the error signal to a server of a not-shown host computer or the like (B9) to report the error (B10), and ends the routine.

On the other hand in B2, if the main CPU 241 determines that the signal is not an error signal (B2: NO), the main CPU 241 determines whether a predetermined time (check time) has elapsed from the time of powering on (B3). If the main CPU 241 determines that the check time has elapsed (B3: YES), B9 is executed. On the other hand, if the main CPU 241 determines that the check time has not yet elapsed (B3: NO), it is determined whether an initial setting signal is received from each of the gaming terminals 3 (B4). If the main CPU 241 determines that an initial setting signal from any one of the gaming terminals 3 is not received (B4: NO), the process returns to B1. On the other hand, if it is determined that initial setting signals from all the gaming terminals 3 are received (B4: YES), the main CPU 241 checks operations of work memories such as RAM 243 or the like, various sensors, various driving mechanisms, and various illuminations (B5). Then, the main CPU 241 determines whether all the check results are normal (B6). If the main CPU 241 determines the check results contain an error (B6: NO), the main CPU 241 executes B9.

On the other hand in B6, if the main CPU 241 determines that all the check results are normal (B6: YES), the main CPU 241 outputs an initial setting signal to all the gaming terminals 3 (B7), and causes the shared display 201 to display a demo-screen (B8). Then, the main CPU 241 ends the routine.

In A7, when the main CPU 41 of each of the gaming terminals 3 determines that an initial setting signal is received from the center controller 200 (A7: YES), the main CPU 41 causes the terminal display 101 to display a demo-screen (A7) The main CPU 41 then ends the routine.

(Operation of Gaming Terminal 3: Terminal Process Routine)

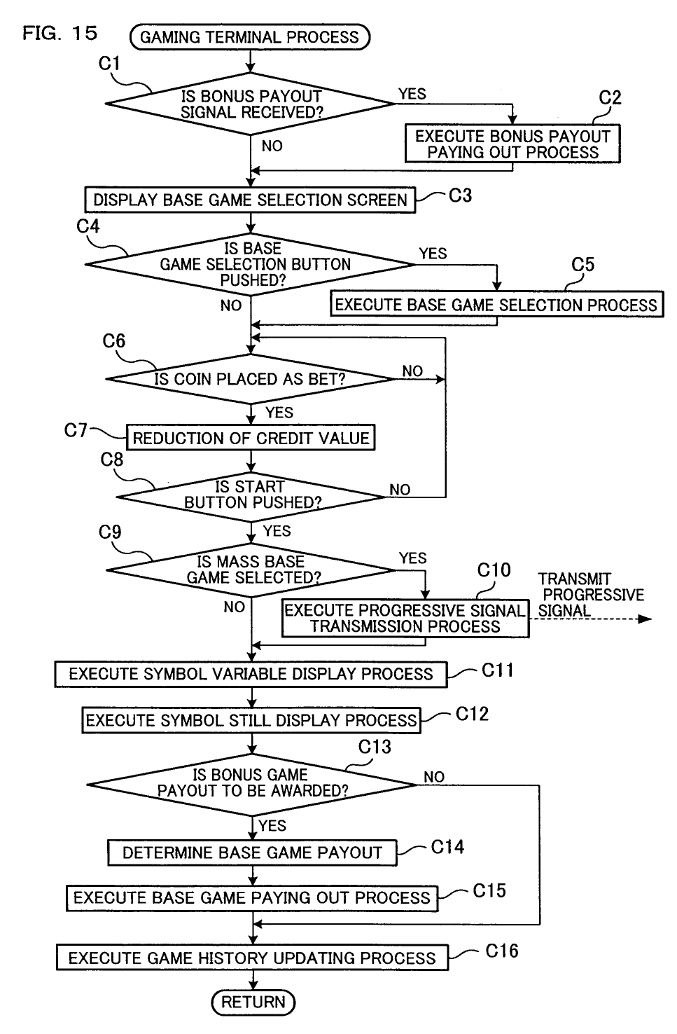

After the terminal side initial setting routine of FIG. 14, the main CPU 41 of the gaming terminal 3 performs a terminal process routine of FIG. 15. Through the gaming terminal process routine executed by the main CPU 41, a game is progressed.

As illustrated in FIG. 15, it is determined in the gaming terminal process routine whether a bonus payout signal is received from the center controller 200 (C1). When a bonus payout signal is received (C1: YES), a payout is awarded to a player, according to a bonus payout amount included in the bonus payout signal (C2).

If no bonus payout signal is received in C1 or after C2 (C1: NO), the base game selection screen is displayed (C3). Specifically, the main CPU 41 outputs a control signal to the graphic board 68, referring to the base game data table. Based on the control signal from the main CPU 41, the graphic board 68 displays on the upper image display panel 33 the base game selection screen indicated in FIG. 5. Thus, a player is able to select a base game.

Note that a control signal from the main CPU 41 includes information on a selectable base game (hereinafter, referred to as selectable base game information) based on game history. Specifically, the results of the last twenty unit games are stored in the RAM 43 as game history. When the game history has no records of unit game where a winning yielding a payout of more than zero, the main CPU 41 outputs to the graphic board 68 a control signal including selectable base game information based on which two out of three mass base games are set as unselectable. As a result, an unselectable base game is displayed as an unselectable base game image 170b whose background is grayed out, as illustrated in FIG. 4.

After C3, it is determined whether the base game selection button 28 is pushed (C4). When the base game selection button 28 is pushed (C4: YES), a base game select process is run (C5). Specifically, the RAM 43 temporarily stores a base game corresponding to a base game image 170a pointed by the base game pointer image 175 which moves each time the base game selection button 28 is pushed, as illustrated in FIG. 5.

Note that when no game is selected by a player, the same base game as the previous one may be automatically selected, or a default base game may be selected.

If the base game selection button is not pushed in C4 or after C5 (C4: NO), it is determined whether a coin is placed as a bet (C6). In this step, it is determined whether a signal from the 1-bet switch 26S entered by pressing of the 1-bet button 26 is received. Meanwhile, it is determined whether a signal from the maximum bet switch 27S entered by pressing of the maximum bet button 27 is received. If no coin is placed as a bet (C6: NO), C6 is repeated until a coin is placed as a bet.

On the other hand, when a coin is placed as bet (C6: YES), the credit value stored in the RAM 43 is deducted according to the number of coins placed as a bet (C7). When the number of coins placed as a bet exceeds the number of coins equivalent to the credit value stored in the RAM 43, C2 is repeated without a reduction of the credit value. When the number of coins placed as a bet exceeds the maximum number of coins bettable for one game (maximum bettable amount set for each base game in this embodiment), the process moves to a later-described step C8 without a reduction of the credit value.

Then, it is determined whether a spin button 23 is pushed (C8). If the spin button 23 is not pushed (C8: NO), the process returns to C6. Here, if the spin button 23 is not pushed (for example, the spin button 23 is not pushed but a command to end the game is input), a result of a reduction of the credit value in C7 is canceled.

Meanwhile, when a spin button 23 is pushed (C8: YES), it is determined in C5 whether the selected base game is a mass base game (C9). When the selected base game is a mass base game (C9: YES), a progressive transmission process is executed (C10). In other words, a progressive signal indicating a part of a bet, is transmitted to the center controller 200.

Further, although it is not shown, when a base game is a mass base game, a remaining amount of a bet after a part of the bet is deducted is stored as an actual bet in a predetermined area of the RAM 43 when the spin button 23 is pushed. Meanwhile, when a game is a single base game, an amount betted is stored as a bet in a predetermined area of the RAM 43 when the spin button 23 is pushed. Further, when a selected base game is a mass base game, a mass base game signal indicating which one of the mass base games is running, is transmitted to the center controller 200 when the spin button 23 is pushed.

When it is determined that the base game is not a mass base game (C9: NO), a symbol variable display process which variably displays the symbols 180 on the upper image display panel 33 is executed (C11). Specifically, the stop symbol determining program stored in the RAM 43 is run to determine the symbols 180 to be stopped in the matrix 156. Further, symbols 180 are variably displayed by scrolling the symbols 180, based on the determined symbols 180 to be stopped.

After the symbols 180 are scrolled in a direction indicated by an arrow, the variable displaying of the symbols 180 is stopped, and the symbols 180 determined in C11 are thereby stopped (rearranged) in the matrix 156 (C12).

Next, it is determined whether a winning is resulted with a combination of the symbols 180 rearranged in the matrix 156 (C13). When it is determined that a winning is resulted (C13: YES), a payout for the base game is determined (C14). Specifically, a payout rate associated with the winning resulted in the selected base game is obtained, referring to the base game payout rate table of FIG. 12. Further, a payout amount for a base game is determined by multiplying the obtained payout rate with the bet amount stored in the RAM 43.

Afterwards, a base game payout process is executed (C15) That is, a payout amount calculated in C14 is awarded to the player. On the other hand, after C15 or when it is determined that no winning is resulted in C13 (C15: NO), a game history update process is executed which stores in RAM 43 a result of a unit game in this routine (C16). Then, this routine ends.

(Operation of Center Controller 200: Center Process Routine)

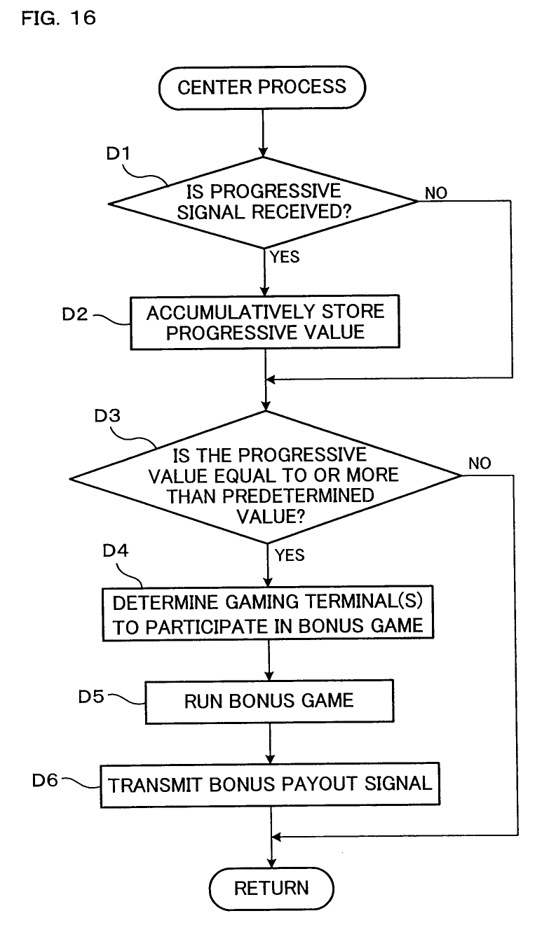

After the center side initial setting routine of FIG. 14, the main CPU 241 of the center controller 200 executes a center process routine of FIG. 16. The main CPU 241 performs the center process routine to progress a shared game.

As illustrated in FIG. 16, in the center process routine, the main CPU 241 determines whether a progressive signal is received from a gaming terminal 3 (D1). If the main CPU 241 determines that a progressive signal is received (D1: YES), a game value indicated by the progressive signal is accumulatively stored (D2).

On the other hand, if the main CPU 241 determines that no progressive signal is received in D1 (D1: NO) or after D2, the main CPU 241 determines if the progressive value equals or surpasses a predetermined value (D3). If the main CPU 241 determines that the progressive value is less than the predetermined value (D3: NO), the routine ends. On the other hand, if the main CPU 241 determines that the progressive value equals or exceeds the predetermined value (D3: YES), one or more participating gaming terminals are determined (D4). Specifically, each of the one or more participating gaming terminals is determined with reference to a gaming terminal management table stored in the RAM 243, and is a gaming terminal 3 which runs a mass base game.

Further, although it is not shown, an updating process of the gaming terminal management table is executed when a mass base game signal from a gaming terminal 3 is received. Specifically, a base game of the gaming terminal management table associated with the gaming terminal 3 which has transmitted the mass base game signal is updated to a type of mass base game included in the transmitted mass base game signal.

Next, a bonus game is run (D5). Specifically, from the participating gaming terminals, a bonus-winning gaming terminal is selected which awards a bonus payout. A bonus-winning gaming terminal 3 may be randomly determined based on a sampled random number, or an amount of a progressive value transmitted from each of the gaming terminals 3. Further, a bonus payout amount is determined in this process. A bonus payout amount may be the total of an accumulatively stored progressive value, or a remaining amount of a progressive value after a predetermined value is added or deducted. Afterwards, a bonus payout signal including a determined bonus payout amount, is transmitted to the determined bonus-winning gaming terminal 3 (D6), and this routine ends.

As is described above, it is determined which one of the base games is run in a gaming terminal 3, based on an input through the base game selection button 28. The base game is then run in response to a bet, independently of another gaming terminal. When a mass base game is to be run, a bet within a wider bettable range compared to a bet on a single base game is permitted, and a part of the bet is accumulatively stored in the bonus payout memory 115. Then, a payout according to a predetermined winning resulted in the base game is awarded based on a payout rate associated with the base game and a bet on the base game. Further, a bonus game is run at a predetermined timing. A bonus-winning gaming terminal 3 is selected out of one or more gaming terminals 3 running a mass base game, based on a predetermined condition. A bonus payout is awarded through the bonus-winning gaming terminal 3 thus determined.

As is understood from the above, any one of the base games out of the plurality of base games is selected by the base game selection button 28. Further, a mass base game permits a bet within a wider bettable range compared to a single base game. Further, a part of a bet on a mass base game is accumulatively stored in the bonus payout memory 115, and used as a bonus payout in a bonus game. Further, each base game has a different payout rate. Thus, a new entertainment characteristic is realized.

Further, as is described above, a result of a base game is stored as history information in the game history memory of each of the gaming terminals 3, based on a predetermined timing. A runnable base game is determined based on this history information. Out of these runnable base games, a base game to be run is selected, based on an input through the base game selection button 28. The base game is then run in response to a bet, independently of another gaming terminal. When a mass base game is to be run, a bet within a wider bettable range compared to a single base game is permitted, and a part of the bet is accumulatively stored in the bonus payout memory 115. Then, a payout according to a predetermined winning resulted in the base game is awarded based on a payout rate associated with the base game and a bet on the base game. Further, a bonus game is run at a predetermined timing. A bonus-winning gaming terminal 3 is selected out of one or more gaming terminals 3 running a mass base game, based on a predetermined condition. A bonus payout is awarded through the bonus-winning gaming terminal 3 thus determined.

Thus, the base game selection button 28 enables a player to select a base game out of the plurality of base games. Further, a mass base game permits a bet within a wider bettable range compared to a single base game. Further, a part of a bet on a mass base game is accumulatively stored in the bonus payout memory 115, and used as a bonus payout awarded in the bonus game. Further, each base game has a different payout rate. In addition, a runnable base game is determined based on history information of a base game. Thus, a new entertainment characteristic is realized.

### Second Embodiment

The following describes a second embodiment of a gaming system according to the present invention. Components identical to those mentioned in the first embodiment will be denoted by the same reference numbers, and no further descriptions for these members are provided here.

(Gaming System 501)

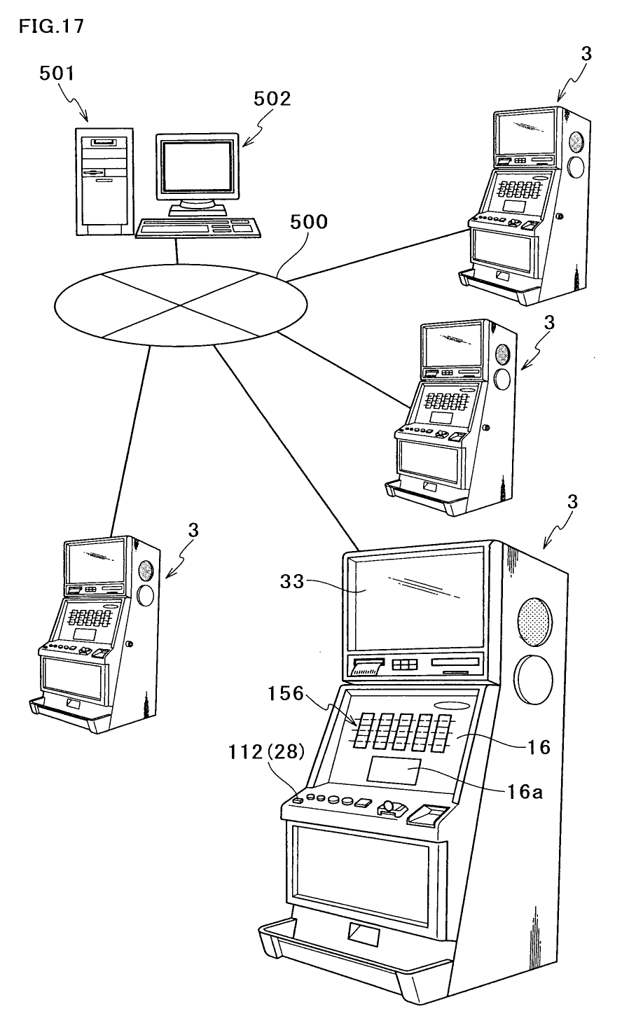

As illustrated in FIG. 17, gaming system 501 includes: a plurality of gaming terminals 3 same as that of the first embodiment; and a management device 502 capable of performing data communication with each of the gaming terminals 3 through a communication line, and has a function of the center controller 200 of the first embodiment.

In other words, the gaming system 501 realizes a playing method in each of the gaming terminals 3, including the steps of: selecting a base game to be run based on an input through an input device 112 (base game selection button 28), out of base games started in response to a bet within a bettable range determined in advance for each of the base games; running the base game in response to a bet, independently of another gaming terminal 3; when the base game is the predetermined base game, permitting a bet within a wider bettable range compared to another base game; awarding a payout according to a predetermined winning resulted in the base game, based on a payout rate associated with the base game and a bet on the base game; and awarding a bonus payout based on a command from the management device 502. The gaming system 501 also realizes a playing method in the management device 502, including the steps of: running a bonus game at a predetermined timing; of the gaming terminals 3, selecting a bonus-winning gaming terminal 3 out of one or more gaming terminals 3 running a predetermined base game, based on a predetermined condition; and commanding the determined bonus-winning gaming terminal 3 to award a bonus payout.

According to the playing method, a base game to be run is selected out of the plurality of base games, based on an input through the base game selection button 28, in each of the gaming terminals 3. The base game is then run in response to a bet, independently of another gaming terminal. When amass base game is to be run, a bet within a wider bettable range compared to a single base game is permitted. Then, a payout according to a predetermined winning resulted in the base game is awarded based on a payout rate associated with the base game and a bet on the base game. Further, a bonus game is run in the management device 502, at a predetermined timing. A bonus-winning gaming terminal 3 is selected out of one or more gaming terminals 3 running a mass base game, based on a predetermined condition. A bonus payout is awarded through the determined bonus-winning gaming terminal 3.

Thus, the base game selection button 28 enables a player to select a base game out of the plurality of base games. Further, a mass base game permits a bet within a wider bettable range compared to a single base game. Further, each base game has a different payout rate. Thus, a new entertainment characteristic is realized.

The playing method realized by the gaming system 501 in the gaming terminals 3 may further include a step of transmitting, to the management device 502, a part of a bet on a predetermined base game (mass base game). The playing method realized in the management device 502 may further include a step of accumulatively storing the received part of the bet in the bonus payout memory 115 which accumulatively stores a part of a bet as a bonus resource.

According to the playing method, a part of a bet on a mass base game, is accumulatively stored in the bonus payout memory 115 of the management device 502. Thus, when a mass base game is to be run in a gaming terminal 3, a part of a bet is accumulatively stored in the bonus payout memory 115 of the management device 502, and used as a bonus payout in the bonus game. Thus, a new entertainment characteristic is realized.

The gaming terminal 3 has the same mechanical structure, electrical structure, display state, and operation as the first embodiment. Further, the management device 502 has the same function as that of the center controller 200, and has the same electrical structure and performs the same operation as the center controller 200. Hence, the description of the gaming terminal 3 and the management device 502 are omitted.

A gaming system 501 including the above-described structure as in the second embodiment brings about the same effect as the first embodiment.

In other words, according to the above structure, a base game to be run is selected out of the plurality of base games, based on an input through the base game selection button 28 in each of the gaming terminals 3. The base game is then run in response to a bet, independently of another gaming terminal. When a mass base game is to be run, a bet within a wider bettable range compared to a single base game is permitted. Then, a payout according to a predetermined winning resulted in the base game is awarded based on a payout rate associated with the base game and a bet on the base game. Further, a bonus game is run in the management device 502, at a predetermined timing. A bonus-winning gaming terminal 3 is selected out of one or more gaming terminals 3 running a mass base game, based on a predetermined condition. A bonus payout is awarded through the determined bonus-winning gaming terminal 3.

Thus, the base game selection button 28 enables a player to select a base game out of the plurality of base games. Further, a mass base game permits a bet within a wider bettable range compared to a single base game. Further, each base game has a different payout rate. Thus, a new entertainment characteristic is realized.

According to the above structure, a pat of a bet on a mass base game is accumulatively stored in the bonus payout memory of the management device 502. Thus, when a mass base game is to be run in a gaming terminal 3, a part of a bet is accumulatively stored in the bonus payout memory 115 of the management device 502, and used as a bonus payout in the bonus game. Thus, a new entertainment characteristic is realized.

Note that the number of gaming terminals 3 is three in the first embodiment. However, the present invention is not limited to this, provided that at least two gaming terminals 3 are provided.

In addition, as in the first embodiment, a base game which a player is allowed to select is determined in the gaming terminal 3, based on a result of a past base game (game history) in the second embodiment. However, the present invention is not limited to this.

The detailed description of the present invention provided hereinabove mainly focused on characteristics thereof for the purpose of easier understanding; however, the scope of the present invention shall be construed as broadly as possible, encompassing various forms of other possible embodiments, and therefore the present invention shall not be limited to the above description. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer or computer network. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes performed in the steps or blocks, these processes are essentially executed by various devices. Further, the other structures necessary for the steps or blocks are obvious from the above descriptions.

What is claimed is:

1. A gaming machine comprising:
a plurality of gaming terminals each having an input device through which an input from outside is inputted, and a terminal controller;
a plurality of base games which start in response to a bet within a bettable range determined in advance for each of the base games;
a payout memory which stores a payout rate set for each of the base games for a predetermined winning;
a bonus game which is configured to award a bonus payout greater than a payout awarded in any of the base games, and which is joinable during a predetermined one of the plurality of base games; and
a bonus payout memory which accumulatively stores a part of a bet on a predetermined base game as a resource for a bonus payout; and
a center controller,
wherein the terminal controller carries out the steps of: (a1) selecting abase game to be run, based on an input through the input device;
(a2) running the base game in response to a bet, independently of another gaming terminal;
(a3) when the base game is the predetermined base game, permitting a bet within a wider bettable range compared to another base game, and accumulatively storing a part of the bet on the predetermined base game, in the bonus payout memory;
(a4) awarding a payout according to a predetermined winning resulted in the base game, based on a payout rate associated with the base game and a bet on the base game; and
(a5) awarding a bonus payout based on a command from the center controller,
and wherein the center controller carries out the steps of: (b1) running a bonus game at a predetermined timing;
(b2) of the gaming terminals, selecting a bonus-winning gaming terminal out of one or more gaming terminals running a predetermined base game, based on a predetermined condition; and
(b3) commanding the terminal controller of the determined bonus-winning gaming terminal to award a bonus payout.

2. A gaming machine comprising:
a plurality of gaming terminals each having an input device through which an input from outside is inputted, a game history memory which stores history information of a game, and a terminal controller;
a plurality of base games which start in response to a bet within a bettable range determined in advance for each of the base games;
a payout memory which stores a payout rate of each of the base games for a predetermined winning;
a bonus game which is configured to award a bonus payout greater than a payout awarded in any of the base games, and which is joinable during a predetermined one of the plurality of base games;
a bonus payout memory which accumulatively stores a part of an bet on a predetermined base game, as a resource for a bonus payout; and
a center controller,
wherein the terminal controller carries out the steps of: (c1) storing in the game history memory a result of a base game as history information, based on a predetermined timing;
(c2) determining one or more runnable base games based on the history information;
(c3) selecting a base game to run out of the one or more base games determined as runnable, based on an input through the input device;
(c4) running a base game in response to a bet, independently of another gaming terminal;
(c5) when the base game is the predetermined base game, permitting a bet within a wider bettable range compared to another base game, and accumulatively storing a part of the bet on the predetermined base game, in the bonus payout memory;
(c6) awarding a payout according to a predetermined winning resulted in the base game, based on a payout rate associated with the base game and a bet on the base game; and
(c7) awarding a bonus payout based on a command from the center controller,
and wherein the center controller carries out the steps of: (d1) running a bonus game at a predetermined timing;
(d2) of the gaming terminals, determining a bonus-winning gaming terminal out of one or more gaming terminals running the predetermined base game, based on a predetermined condition; and
(d3) commanding the terminal controller of the thus determined bonus-winning gaming terminal to award a bonus payout.

3. A gaming system comprising:
a plurality of base games which start in response to a bet within a bettable range determined in advance for each of the base games;
a plurality of gaming terminals each having an input device through which an input from outside is inputted, a payout memory which stores a payout rate of each of the base games, for a predetermined winning;
a bonus game which is configured to award a bonus payout greater than a payout awarded in any of the base games, and which is joinable during a predetermined one of the plurality of base games; and
a management device having a center controller, which is capable of performing data communication with each of the gaming terminals,
wherein the terminal controller carries out the steps of: (e1) selecting a base game to run out of the plurality of base games, based on an input through the input device;
(e2) running a base game in response to a bet, independently of another gaming terminal;
(e3) when the base game is the predetermined base game, permitting a bet within a wider bettable range compared to another base game;
(e4) awarding a payout according to a predetermined winning resulted in the base game, based on a payout rate associated with the base game and a bet on the base game; and
(e5) awarding a bonus payout based on a command from the center controller,
and wherein the center controller carries out the steps of: (f1) running a bonus game at a predetermined timing;
(f2) of the gaming terminals, selecting a bonus-winning gaming terminal out of one or more gaming terminals running the predetermined base game, based on a predetermined condition; and
(f3) commanding the terminal controller of the thus determined bonus-winning gaming terminal to award a bonus payout.

4. The gaming system according to claim 3, wherein:
the management device further includes a bonus payout memory which accumulatively stores a part of a bet on the predetermined base game as a resource of a bonus payout;
the terminal controller transmits to the management device a part of a bet on a predetermined base game; and
the center controller accumulatively stores the received part of the bet in the bonus payout memory.

5. A playing method of a gaming machine comprising the steps of:
(g1) in each of a plurality of gaming terminals, selecting a base game to run out of a plurality of base games, based on an input through an input device which receives an input from outside, the plurality of base games configured to start in response to a bet within a bettable range determined in advance for each of the base games;
(g2) running the base game in response to a bet, independently of another gaming terminal;
(g3) when the base game is a predetermined base game, permitting a bet within a wider bettable range compared to another base game, and accumulatively storing a part of the bet in a bonus payout memory, the predetermined game being a game during which a player is allowed to join a bonus game configured to award a bonus payout greater than a payout awarded in any of the base games, the bonus payout memory storing a resource for a bonus payout;
(g4) awarding a payout according to a predetermined winning resulted in the base game, based on a payout rate associated with the base game and a bet on the base game;
(g5) running the bonus game at a predetermined timing;
(g6) of the gaming terminals, determining a bonus-winning gaming terminal out of one or more gaming terminals running the predetermined base game, based on a predetermined condition; and
(g7) awarding a bonus payout through the thus determined bonus-winning gaming terminal.
